(19) United States
(12) Patent Application Publication
(10) Pub. No.: US 2026/0080493 A1
(43) Pub. Date: Mar. 19, 2026

(54) ADD-ON CAPABILITIES TO GUARANTEE SAFE RESPONSES TO EMERGENCY STOPS

(71) Applicant: 3Laws Robotics Inc., Pasadena, CA (US)

(72) Inventors: Andrew W. Singletary, Pasadena, CA (US); Thomas Gurriet, Pasadena, CA (US)

(21) Appl. No.: 19/007,261

(22) Filed: Dec. 31, 2024

Related U.S. Application Data
(60) Provisional application No. 63/694,914, filed on Sep. 15, 2024.

(51) Int. Cl. G06Q 50/26

(52) U.S. Cl. CPC G06Q 50/265

(57) ABSTRACT

Methods, systems, and computer program products for safe operation of computer-aided cyber-physical systems in case of an emergency. Computing processors execute sequences of instructions that cause the computing processor to perform acts comprising (1) identifying a first module, wherein the first module is integrated into a cyber-physical system, and wherein the first module responds to an emergency response signal by initiating functions that are configured to achieve a first emergency response state; and (2) configuring a second module to be integrated into the cyber-physical system, wherein the second module responds to the emergency response signal or a derivative of the emergency response signal by initiating functions of the second module that are configured to achieve a second emergency response state. In various deployments, the first module is integrated into the cyber-physical system. Then, as an add-on or retrofit, the second module is added onto or into the cyber-physical system.

### RELATED APPLICATIONS

The present application claims the benefit of priority to U.S. Provisional Patent Application Ser. No. 63/694,914 titled “SAFE ROBOTIC RESPONSES TO HUMAN-INITIATED EMERGENCY STOPS” filed on Sep. 15, 2024, which is hereby incorporated by reference in its entirety.

### TECHNICAL FIELD

This disclosure relates to computer-aided cyber-physical systems, and more particularly to techniques for integrating add-on capabilities to guarantee safe responses to emergency stops (e.g., human-initiated emergency stops and/or autonomously initiated emergency stops).

### BACKGROUND

Nowadays, robots are everywhere. Robots were introduced to the corpus of science back in the 1950s. Since then, engineers have been diligently developing robotic capabilities. For example, some initial work was done on what we call today “numerical control,” which is basically just saying that a machine (such as a lathe or other sort of machine tool) was being controlled by a computer. Since then, a great amount of work has been done on what is known today as computer vision, which is commonly used in modern day robotic systems. More recently researchers have been successful at deploying autonomous vehicles, including automobiles and drones, where the robotic system (sometimes known as a cyber-physical system) is configured for 100% autonomous operation given some parameters or objectives such as what is commonly called a “mission”. In fact, in recent times multiple cyber-physical systems have been deployed to accomplish what one might consider to be very complex operations/missions. For example, on a factory floor, a first robot might be deployed to move some feedstock from a supply dock or supply palette to a location proximal to a second robot, such as a robotic arm. Then the robotic arm might move some portion of the feedstock into a component (e.g., a chuck) of a numerical controlled machine tool. To accomplish this, multiple robots might be configured, either individually or in combination, to be coordinated (or to coordinate autonomously among themselves) to accomplish relatively complex objectives.

One fundamental law of robotics, namely “The first law of robotics” is that “A robot may not injure a human being or, through inaction, allow a human being to come to harm.” This is drawn from “The Three Laws of Robotics,” proposed by science and science-fiction writer Isaac Asimov. While this is a soothing law or idea, it has to be actually implemented by the workings of the cyber-physical system. Moreover, there are further laws or corollaries that state, “A robot may not cause damage or injury to itself,” and “A robot, through inaction, may not cause damage or injury to itself.”

It has proven to be more challenging to implement the first law of robotics (e.g., the first law) and its corollaries than it is to merely write or say. Moreover, even though the simple idea that the robots envisioned by Isaac Asimov do not cause injury to humans or cause damage to themselves, it can sometimes happen during development or testing or initial deployment into a new environment that a human operator might disagree with (or otherwise want to override) an action that the robotic system is carrying out or is about to carry out. A human-operated emergency stop facility (e.g., an “Emergency Stop” button or lever) is provided as a last resort.

Such human-operated emergency stop facilities are often naïve as pertains to the robot's overall environment. For a further understanding, consider again the scenario where there are multiple robots involved. The first robot is tasked with moving feedstock from the supply palette to a location proximal to a second robot such as the aforementioned robotic arm. Now suppose there is a human operator or a human observer that is in a position to either allow the robots to interoperate, or to cause one or more of the robots to execute some “emergency stop” protocol (e.g., the human would “hit” the emergency stop button). In some situations, executing such an emergency stop protocol might be as simple as cutting power to the autonomous machine. For example, if the aforementioned lathe were to merely stop rotating and/or cutting the feedstock, it might be that there is no chance for injury to the human, and no chance for damage to the lathe. However, there are situations that arise where merely cutting power to the autonomous system is not only undesirable with respect to achievement or backsliding with respect to the mission but, in some cases, merely cutting power to the autonomous system would cause damage to the observer or robot—thus violating the first law and/or its corollaries.

Continuing the foregoing scenario where the first robot is moving feedstock from the supply palette to a location proximal to a second robot, merely cutting power to the first robot during the moving operation might end up with the first robot dropping the feedstock in an uncontrolled manner. This is undesirable and might indeed violate the first law of robotics, in this case dropping the feedstock in an uncontrolled manner might damage the locomotion apparatus of the first robot. This is allegorically similar to someone dropping something on one's own foot.

Unfortunately, although the concept of an emergency stop (used herein interchangeably with the term “E-Stop”), is a notoriously old-in-the-art concept, and although legacy implementations are similarly well known, the handling of an emergency stop protocol needs to avail of technologies to advance the art. What is needed are technical advances so as to automatically (e.g., under computer control) be able to safely carry out autonomous system responses to human-initiated emergency stops—yet without violating the first law of robotics. More particularly, what is needed is a way to reach a safe emergency response state via traversal through a series of (only) safe states that are achieved through a series of (only) safe behaviors.

The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for safe robotic responses to human-initiated emergency stops, which techniques advance the relevant technologies to address technological issues with legacy approaches. More specifically, the present disclosure describes techniques used in systems, methods, and in computer program products for safe robotic responses to human-initiated emergency stops. Certain embodiments are directed to technological solutions for designing and guaranteeing well-defined and safe robotic responses to human-initiated emergency stops. Certain embodiments are directed to technological solutions for adding on well-defined and safe robotic responses that augment the functionality of pre-existing robot emergency stop facilities.

The disclosed embodiments modify and improve beyond legacy approaches. In particular, the herein-disclosed techniques provide technical solutions that address the technical problems attendant to undefined or dangerous robotic responses to human-initiated emergency stops. Such technical solutions involve specific implementations (e.g., data organization, data communication paths, module-to-module interrelationships, etc.) that relate to the software and hardware arts for improving computer functionality.

More particularly, disclosed herein are technical advances that automatically (e.g., under computer control) are able to safely carry out actions/responses to human-initiated emergency stops—yet without violating the first law of robotics. More particularly, disclosed herein are ways to add-on to or otherwise retrofit or augment a pre-existing emergency stop module by integrating an add-on module as a further, add-on, retrofitted emergency stop module that is configured to reach a safe emergency response state via traversal through a series of (only) safe states that are achieved through a series of (only) safe behaviors.

The ordered combination of steps of certain of the stepwise-oriented embodiments serve in the context of practical applications that perform steps to carry-out well-defined and safe robotic responses to human-initiated emergency stops. As such, these techniques for defining and deploying well-defined and safe robotic responses to human-initiated emergency stops overcome long-standing yet heretofore unsolved technological problems associated with undefined or dangerous robotic responses to human-initiated emergency stops, which problems arise in the realm of robotic systems.

Many of the herein-disclosed embodiments that prescribe well-defined and safe robotic responses to human-initiated emergency stops are technological solutions pertaining to technological problems that arise in the hardware and software arts that underlie electronic cyber-physical systems.

Some embodiments include a sequence of instructions that are stored on a non-transitory computer readable medium. Such a sequence of instructions, when stored in memory and executed by one or more processors, causes the one or more processors to perform a set of acts for designing and guaranteeing well-defined and safe robotic responses to human-initiated emergency stops.

Some embodiments include the aforementioned sequence of instructions that are stored in a memory, which memory is interfaced to one or more processors such that the one or more processors can execute the sequence of instructions to cause the one or more processors to implement acts for designing and guaranteeing well-defined and safe robotic responses to human-initiated emergency stops.

Some embodiments include one or more add-on modules that comprise one or more safety functions that are configured such that, in response to an emergency stop input (e.g., event or signal), the safety function by itself or in coordination with other modules, creates or causes to be created, a stabilizing action that keeps a subject cyber-physical system (e.g., a humanoid robot) in a stable, nominal position and/or state (e.g., in an upright position and stopped, or in a quiescent state). In some embodiments, one or more control barrier functions are used to ensure that such a stable, nominal position and/or state corresponds to an emergency response position and/or state that is achieved via traversal through a series of (only) safe states that are in turn achieved through a series of (only) safe movements or behaviors.

In various embodiments, any combination of any of the above can be organized to perform any variation of acts for performing safe robotic responses to human-initiated emergency stops, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A1 exemplifies undesired behavior of a cyber-physical system.

FIG. 1A2 exemplifies safe operational behavior of a cyber-physical system that implements safe robotic responses to human-initiated emergency stops, according to an embodiment.

FIG. 1B1 exemplifies legacy implementations of emergency stops in a cyber-physical system.

FIG. 1B2 exemplifies a safe emergency stop implementation that interacts with a pre-existing emergency stop module, according to an embodiment.

FIG. 1B3 exemplifies a holistic safe behavior implementation that interacts with a pre-existing emergency stop module, according to an embodiment.

FIG. 2A exemplifies a method for configuring software code in a cyber-physical system so as to achieve safe robotic responses to human-initiated emergency stops, according to an embodiment.

FIG. 2B1 exemplifies a method for configuring electronic components of a cyber-physical system that includes a combination of hardware and software to achieve safe robotic responses to human-initiated emergency stops, according to an embodiment.

FIG. 2B2 exemplifies use of integration mechanisms for configuring a cyber-physical system so as to achieve safe robotic responses to human-initiated emergency stops, according to an embodiment.

FIG. 2C1, FIG. 2C2, and FIG. 2C3 are presented to illustrate different arrangements of electronic components of a cyber-physical system, according to various embodiments.

FIG. 2D1 depicts a software integration technique for adding enhanced functionality that guarantees safe robotic responses to human-initiated emergency stops, according to an embodiment.

FIG. 2D2 depicts a hardware integration technique for adding enhanced functionality that guarantees safe robotic responses to human-initiated emergency stops, according to an embodiment.

FIG. 3 depicts system components as arrangements of computing modules that are interconnected so as to implement certain of the herein-disclosed embodiments.

FIG. 4 depicts a system as arrangements of computing modules that are interconnected so as to implement a second supervisory control layer having a machine-learning predictor module, according to various embodiments.

FIG. 5A depicts a block diagram of an instance of a computer system suitable for implementing embodiments of the present disclosure.

FIG. 5B depicts an environment in which a behavior guarantee module can be implemented.

FIG. 5C1 depicts a block diagram of an interstitially situated supervisory layer, in accordance with some implementations.

FIG. 5C2 depicts a block diagram involving a human operator's safe manipulation of a robotic control system, in accordance with some implementations.

FIG. 5D depicts a safe signal generation technique, in accordance with some implementations.

### DETAILED DESCRIPTION

Aspects of the present disclosure solve problems associated with using computer systems to avoid undefined or dangerous robotic responses to human-initiated emergency stops. These problems are unique to, and may have been created by, various legacy computer-implemented methods that can result in undefined or dangerous robotic responses to human-initiated emergency stops in the context of computer-aided cyber-physical systems. Some embodiments are directed to approaches for designing and guaranteeing well-defined and safe robotic responses to human-initiated emergency stops. Some embodiments are directed to approaches for augmenting pre-existing emergency stop facilities with further facilities that guarantee well-defined and safe robotic responses to human-initiated emergency stops. The accompanying figures and discussions herein present example environments, systems, methods, and computer program products for safe robotic responses to human-initiated emergency stops.

### Overview

The disclosures herein advance over legacy techniques. As mentioned above with respect to legacy systems, executing a (deficient) emergency stop protocol might be as simple as cutting power to the autonomous machine. However, there are situations that arise where merely cutting power to the autonomous system is not only undesirable with respect to achievement or backsliding with respect to the mission but, in some cases, merely cutting power to the autonomous system would cause damage to the observer or robot—thus violating the first law and/or its corollaries.

In a scenario where a first robot is moving feedstock from a supply palette to a location proximal to a second robot, merely cutting power to the first robot during the moving operation might end up with the first robot dropping the feedstock in an uncontrolled manner. This is undesirable and might indeed violate the first law of robotics, in this case dropping the feedstock in an uncontrolled manner might damage (for example) the locomotion apparatus of the first robot.

Although the concept of an emergency stop (used herein interchangeably with the term “E-stop”), is a notoriously old-in-the-art concept, and although legacy implementations are similarly well known, the handling of an emergency stop protocol in a safe manner is the technological advance that is disclosed herein. What is needed are implementations that automatically (e.g., under computer control) and safely carry out autonomous system responses to human-initiated emergency stops—yet without violating the first law of robotics. Moreover, what is needed are implementations that augment pre-existing E-stop functionality to as to automatically (e.g., under computer control) and safely carry out autonomous system responses to human-initiated emergency stops.

To further explain, it often happens that cyber-physical systems (e.g., robots) have designed-in (e.g., pre-existing) E-stop functionality. However, it also often happens that the designed-in E-stop functionality of such cyber-physical systems fail to consider all of the possible options for safe behavior under an E-stop situation. As such, what is needed is for the designed-in E-stop functionality of a particular cyber-physical system to be augmented or otherwise modified so as to command the robot to perform only safe behaviors that are in turn carried out autonomously by the cyber-physical system.

One of a range of possible implementations of carrying out autonomous system responses to human-initiated emergency stops involves implementation of a safety layer in a cyber-physical system. Another one of a range of possible implementations of carrying out autonomous system responses to human-initiated emergency stops involves implementation of mathematical models of safe (e.g., bounded) robotic operations regardless of instructions to the contrary. Another one of a range of possible implementations of carrying out autonomous system responses to human-initiated emergency stops involves implementation of operational modules that are configured to permit only safe robotic operations regardless of instructions to the contrary. Performing only safe robotic operations regardless of instructions to the contrary often involves overriding commands or signals that are provided by pre-existing E-stop modules.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more”unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

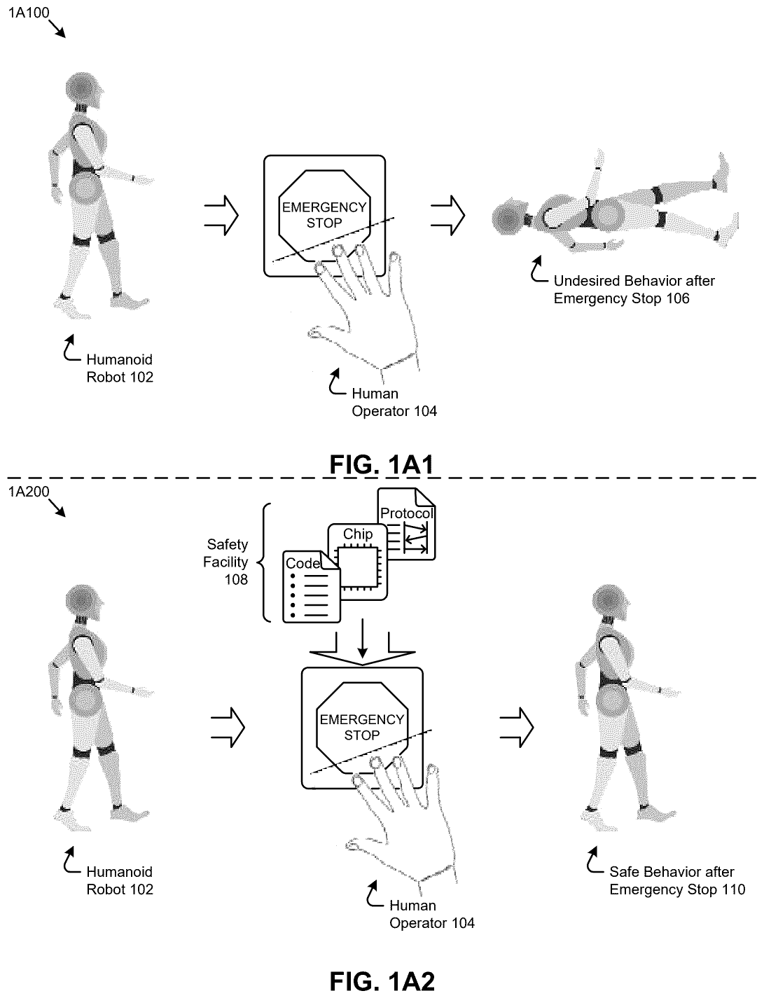

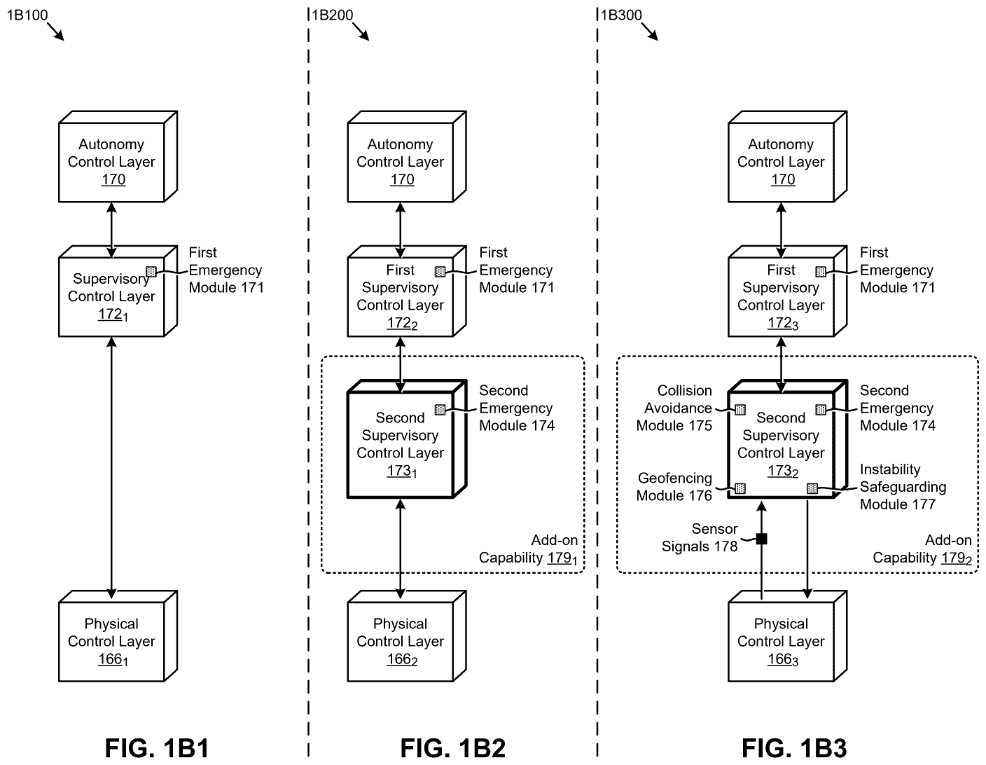

FIG. 1A1 and FIG. 1A2 are being presented on the same sheet to compare a first configuration of a system that contrasts undesired behavior of a first configuration 1A100 of a cyber-physical system with desired behavior of a second configuration 1A200 of a second cyber-physical system. Specifically, in FIG. 1A1, the humanoid robot 102 is subjected to an emergency stop by a human operator 104, and ends up falling over, possibly causing harm to the humanoid robot (or to elements in its environment), which is indeed undesired behavior after an emergency stop operation 106.

What is desired is depicted in FIG. 1A2, where humanoid robot 102 maintains safe behavior after emergency stop 110. In terms of the differences between the first configuration and the second configuration, it should be noted that safety facility 108 is added to the existing emergency stop functionality. As shown, and purely for illustrative purposes, safety facility 108 includes safety code, a safety chip, and a safety protocol. Other implementations of a safety facility are possible, some of which may include various instances of and/or absence of any one or more of safety code, a safety chip, and a safety protocol.

The foregoing discussion of FIG. 1A2 pertains to merely some possible embodiments and/or ways to implement safe operational behavior through use of a safety facility 108. Many variations are possible, for example, software code to implement the safe operational behavior as comprehended in the foregoing can be implemented in any cyber-physical system and/or on any environment, one example of which is shown and described as pertains to FIG. 1B1, FIG. 1B2, and FIG. 1B3.

FIG. 1B1 exemplifies legacy implementations 1B100 of emergency stops in a cyber-physical system. As shown, autonomy control layer 170 interacts with supervisory control layer 172₁, which in turn interacts with a physical control layer 166₁. In this configuration, an occurrence of an emergency response signal serves to invoke all or portions of the first emergency module of the cyber-physical system so as to achieve a first emergency response state by supervising or otherwise communicating with physical control layer 166₁.

In this legacy implementation, it should be noted that there is no second emergency module that is particularly configured to achieve a second emergency response state that is achieved via only safe behaviors of the cyber-physical system. Indeed, it becomes apparent that what is needed is a second, add-on emergency module that is configured to achieve the second emergency response state via only safe behaviors.

As used herein, in reference to the term “retrofit”, and in reference to the terms “add-on” or “add-on module”, or “add-on capability” or “add-on component(s)” refer to integrating an aspect of an article of manufacture that did not have the aspect in it or on it or with it when the article was manufactured and/or did not have the component or accessory or function before the integration was performed. In various emergency stop implementations, an “add-on module” or “retrofit module” refers to an emergency stop facility that, once integrated through a retrofit, augments or supplants any pre-existing emergency stop facility of a cyber-physical system.

FIG. 1B2 exemplifies a safe emergency stop implementation 1B200 (e.g., second emergency module 174 within the shown add-on capability 179₁) that interacts with a pre-existing emergency stop module (e.g., first emergency module). In this implementation, there are two supervisory control layers, shown as (1) a first supervisory control layer 172₂, and (2) a second supervisory control layer 173₁. Operational components of the second supervisory control layer are configured to override certain behaviors that are brought about or sought by the first supervisory control layer. In this particular implementation, a first set of behaviors are brought about a first emergency module 171 (as shown within the first supervisory layer) whereas a second set of (safe) behaviors are brought about a second emergency module 174 (as shown within the second supervisory layer). The second emergency module may include emergency stop handling procedures that adhere to particularly-defined control bounds and that correspond to or influence behavior of any one or more of, a collision avoidance module 175, a geofencing module 176, and/or an instability safeguarding module 177. As such, the second set of (safe) behaviors are guaranteed to be safe, at least by virtue of the second supervisory layer's adherence to particularly-defined control bounds.

Further details regarding general approaches to implementing a cyber-physical system that can safely carry out operations within particularly-defined bounds are described in PCT Application Ser. No. PCT/US23/72532 titled “ROBOTIC SIGNAL SUPERVISOR FOR SAFETY GUARANTEES” filed on Aug. 20, 2023, which is hereby incorporated by reference in its entirety.

In this configuration, an occurrence of an emergency response signal serves to invoke all or portions of both (1) the first emergency module of the cyber-physical system as well as (2) the second emergency module of the cyber-physical system so as to achieve a safe emergency response state by supervising or otherwise communicating with physical control layer 166₂.

The shown add-on capability 179₁ can be further augmented so as to provide for a range of safe behaviors that correspond to a range of risks and/or environmental situations.

FIG. 1B3 exemplifies a holistic safe behavior implementation that interacts with a pre-existing emergency stop module. The holistic safe behavior implementation 1B300 (e.g., second emergency module 174 within the shown add-on capability 179₂) interacts with a pre-existing emergency stop module (e.g., first emergency module). In this implementation, there are two supervisory control layers, shown as (1) a first supervisory control layer 172₃, and (2) a second supervisory control layer 173₂. Operational components of the second supervisory control layer are configured to respond to dynamically changing operational conditions (e.g., proximities, traffic, environments, etc.) as well as to override certain behaviors that are brought about or sought by the first supervisory control layer. The second set of (safe) behaviors are guaranteed to be safe, at least by virtue of the second supervisory layer's adherence to particularly-defined control bounds.

The occurrence of an emergency response signal (e.g., any one or more of, a human-initiated emergency response signal, or an autonomously-raised emergency response signal, or a derivative emergency response signal) invokes all or portions of both (1) the first emergency module of the cyber-physical system and/or (2) the second emergency module of the cyber-physical system so as to achieve a safe emergency response state by supervising or otherwise communicating with physical control layer 166₃. In this configuration, the physical control layer 166₃ is configured with physical condition sensors. As shown, signals (e.g., sensor signals 178) from said physical condition sensors of physical control layer 166₃ are passed upward to the second emergency module of the cyber-physical system. Such signals can be used to fine tune or otherwise modify the operations of the second emergency module of the cyber-physical system so as to achieve a safe emergency response state under even rapidly-changing conditions.

The cyber-physical systems of FIG. 1B1, FIG. 1B2, and FIG. 1B3 exemplify techniques for configuring a second emergency stop module (e.g., software code, firmware code, metadata, scripts, parameters, etc.) in a cyber-physical system that augments a pre-existing first emergency stop module such that, in use, the combination of the second emergency stop module with the pre-existing first emergency stop module achieves safe robotic responses to human-initiated emergency stops.

As used herein, and in some embodiments, an emergency stop module refers to any operational unit (e.g., hardware, software, or a mixture of hardware and software) that receives and/or initiates a response to a human-initiated emergency stop signal. In certain other settings and/or embodiments, an emergency stop module refers to any operational unit (e.g., hardware, software, or a mixture of hardware and software) that is itself an operational unit that is either (1) triggered by humans under what is often called manual control, or (2) triggered by humans under what is often called manual control, or (3) triggered based on the basis of cyber-physical system conditions (e.g., motor anomalies or failures, safety sensor activations, component statuses, etc.) that are either solely based on cyber-physical system conditions or are referred to in combination with environmental conditions.

In certain other settings and/or embodiments, an emergency stop module refers to any operational unit (e.g., hardware, software, or a mixture of hardware and software) that is itself an operational unit that is either (1) triggered by humans under what is often called manual control, or (2) triggered based on the basis of cyber-physical system conditions (e.g., motor anomalies or failures, safety sensor activations, component statuses, etc.) that are either solely based on environmental conditions or are referred to in combination with cyber-physical system conditions. In some situations and embodiments, an emergency stop module refers to any operational unit (e.g., hardware, software, or a mixture of hardware and software) that comprises an automatic safety system and/or works autonomously in conjunction with automatic safety systems, whether such automatic safety systems are deemed to be responses to “emergencies” or whether such automatic safety systems are deemed to be addressing a broader class of safe robotic operation, whether rising to the level of an emergency or not.

Implementations of the foregoing second emergency stop module might involve substantial amounts of custom software code that runs on pre-existing hardware components, or implementations of the foregoing second emergency stop module might involve substantial amounts of custom hardware that interfaces with pre-existing hardware.

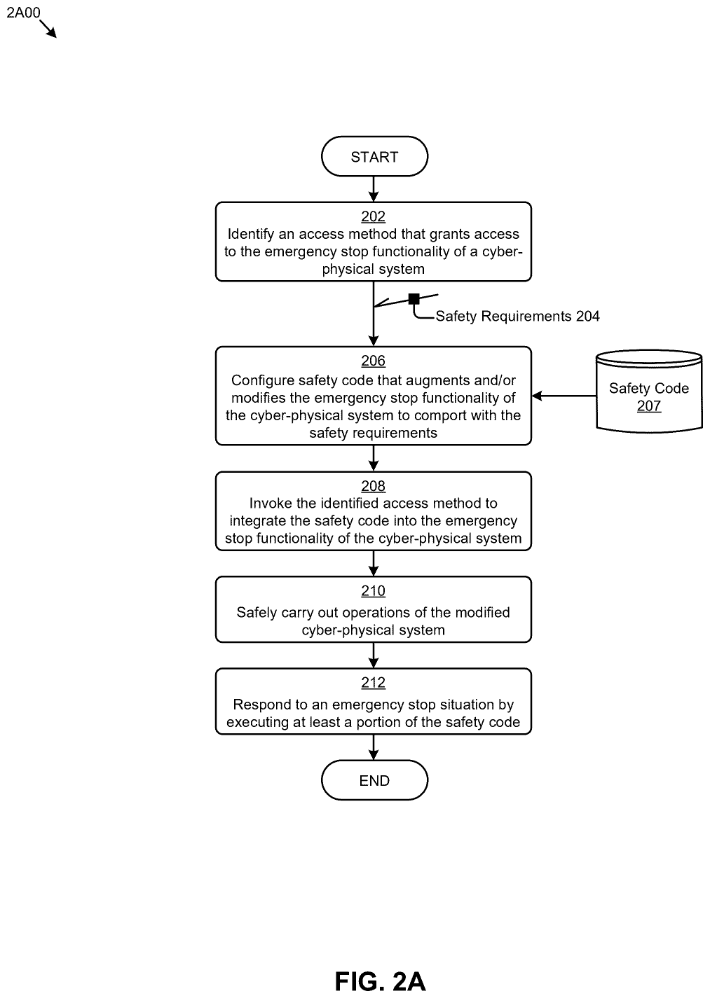

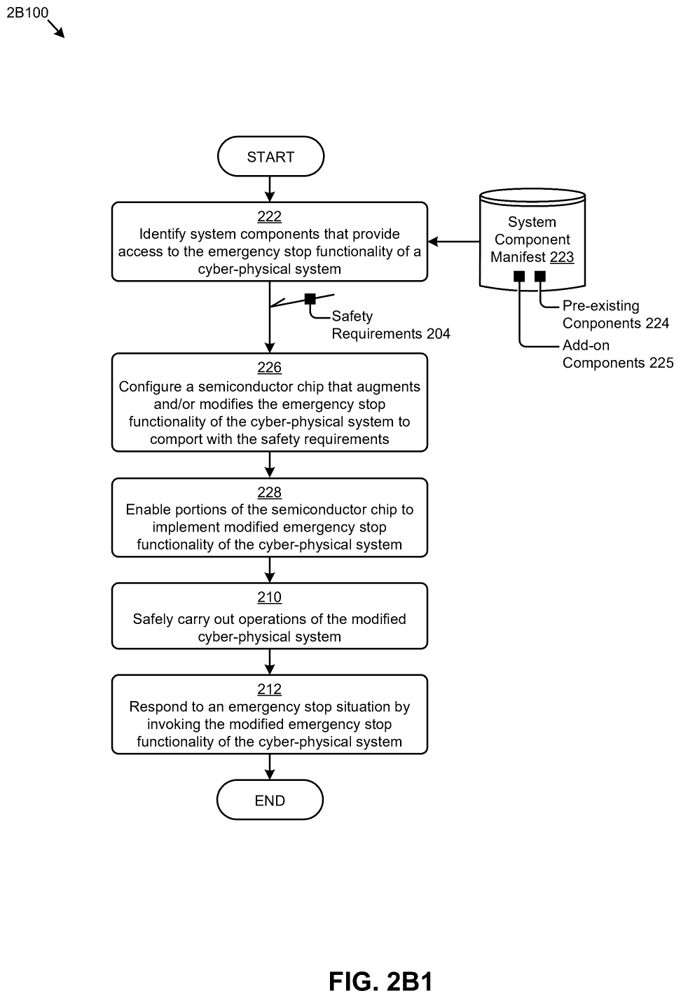

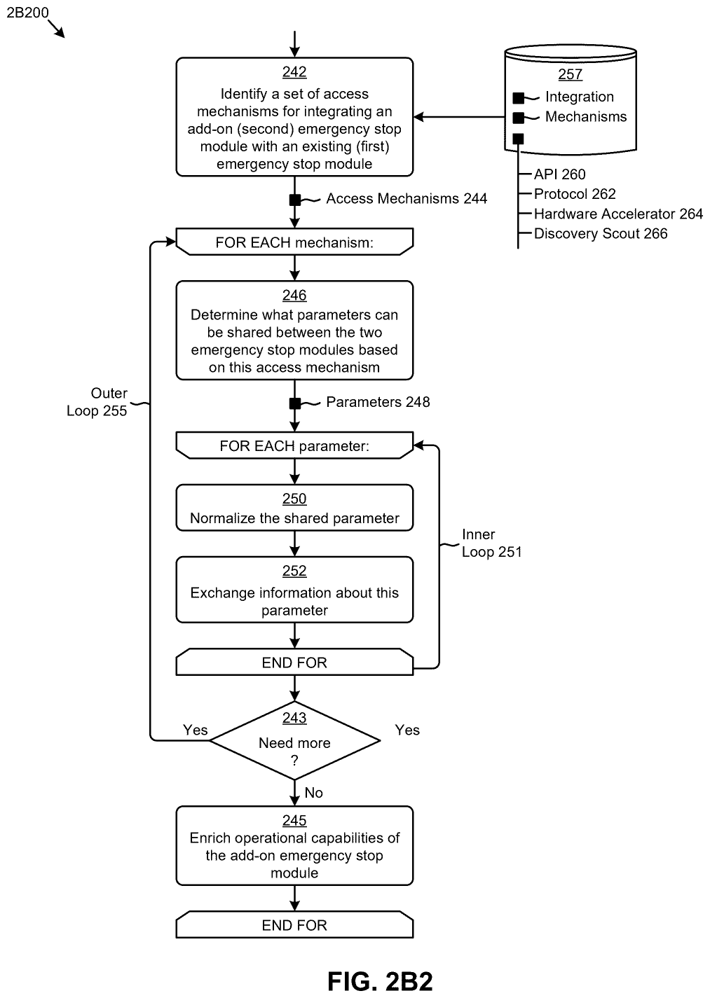

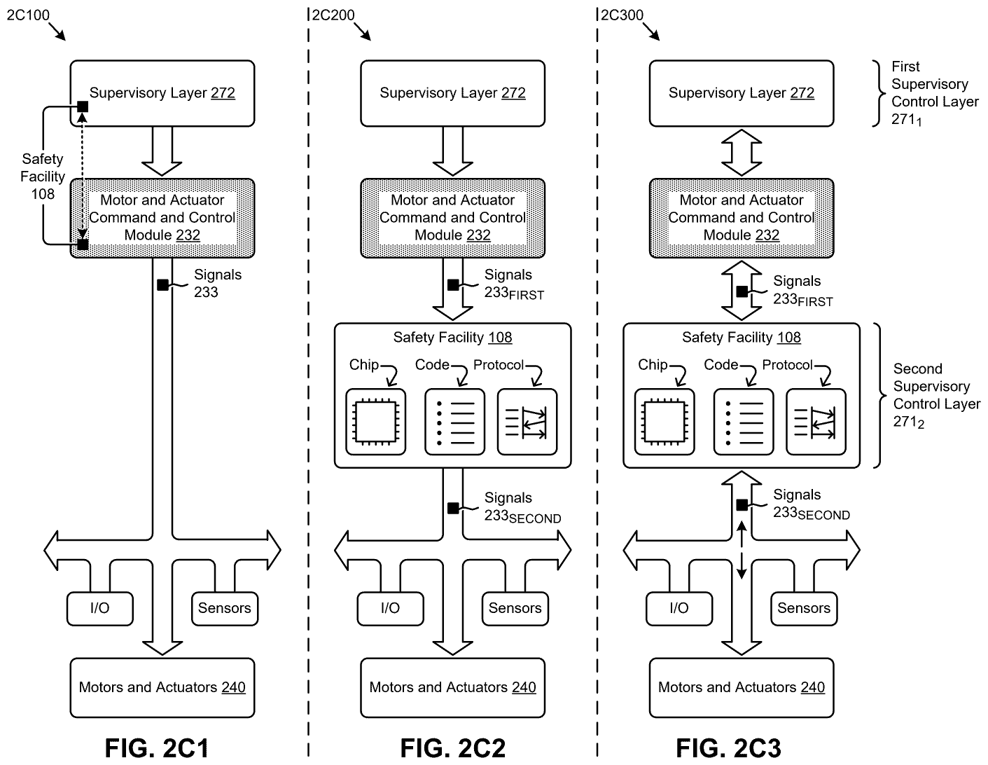

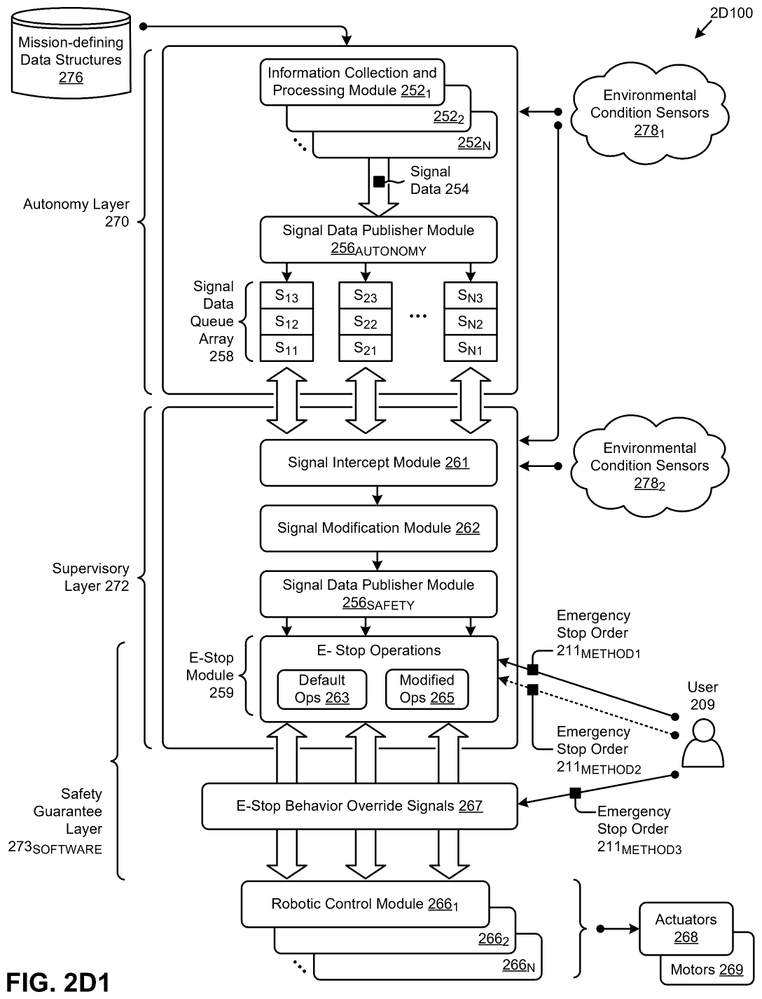

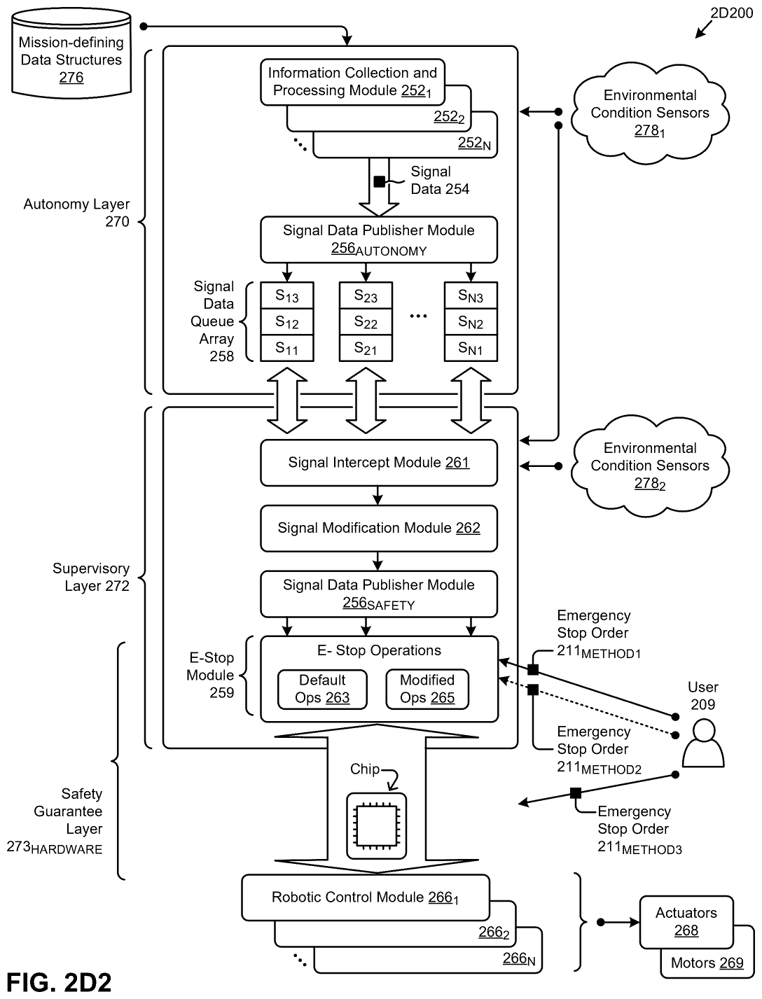

Various implementation options are shown and described as pertains to FIG. 2A, FIG. 2B1, and FIG. 2B2.

FIG. 2A exemplifies a method for configuring software code in a cyber-physical system so as to achieve safe robotic responses to human-initiated emergency stops. As an option, one or more variations of cyber-physical system method 2A00 or any aspect thereof may be implemented in the context of the architecture and functionality of the embodiments described herein and/or in any environment. The figure is being presented to illustrate how a cyber-physical system might be configured to implement a safety facility using software code.

As shown, the method has a starting point and an ending point. Such a starting point and ending point are merely for illustration and other starting points and/or ending points are possible. In this embodiment, the steps between the shown start and the shown end include step 202 that serves to identify an access method that grants access to the (pre-existing) emergency stop functionality of a cyber-physical system. Once such access is granted, then the technological advances of the herein-disclosed system carries out any number of operations that fall under step 206. In particular, and in exemplary embodiments, operations that fall under step 206 involve interpretation and consideration of safety requirements 204. Such safety requirements can arise from any known corpus of safety requirements. Further such safety requirements can be codified in any manner and/or accessed by any known techniques.

Strictly as one example, step 206 serves to configure safety code that instantiates, and/or augments and/or modifies a collection of emergency stop functionalities of the cyber-physical system to comport with the safety requirements 204. Carrying out operations before initiation of step 206, and/or carrying out operations that underlie step 206, might involve executing an exchange with the pre-existing system using a communication protocol.

Such a communication protocol might be a custom protocol that is specific to the pre-existing system, or such a communication protocol might be a vendor-agnostic protocol, or such a communication protocol might comport substantially with an industry-standard protocol that is adopted and supported by the vendor of the cyber-physical system.

The industry standard ISO 13849 is mentioned here strictly to exemplify protocols that are intended to be adopted and supported by the vendors of cyber-physical systems. Adoption and adherence to such standards are intended to ensure the safety of machinery and industrial robots through use of so-called safety functions. To explain, safety functions are specific protective mechanisms or processes within a robot safety system that ensure the safe operation of robotic systems, particularly in environments where humans and robots may interact. Such safety functions serve to prevent accidents, injuries, or equipment damage. In some cases, such safety functions comply with industry standards (e.g., the foregoing ISO 13849 and ISO 10218).

Safety functions are replete with features including (among other features) hazard detection and corresponding hazard detection responses such as active transitions to a safe state. Such hazard detection and response features serve to gauge the risk of occurrence of potentially hazardous conditions (e.g., risk of collisions, risk and/or impact of over-speed operation, or risk and/or impact of incorrect positioning) and respond appropriately by invoking remedial responses (e.g., by stopping the robot or altering its behavior). Various features are combined to achieve reliability (e.g., sometimes through architectures that include redundant systems to ensure that robot operation is predictably within specified performance even in case of certain hardware and/or software failures). In some cases, such standards offer the promise of fail-safe operation or other safe operations that default to a safe state if a fault is detected (e.g., stopping robot motion when a sensor fails).

As can be inferred from the foregoing, ISO 13849 focuses on the safety-related parts of control systems. The standard includes (1) risk assessment and/or other mechanisms for identifying potential hazards (and assessing corresponding risks), (2) safety functions themselves, where such safety functions serve to avoid or mitigate risks, and (3) ongoing validation, which validation serves to ensure that the safety functions perform as intended.

The industry standard ISO 10218 is mentioned here strictly to exemplify protocols that are intended to be adopted and supported by the designers of cyber-physical systems. In particular, ISO 10218 deals with designing in operational safety in mobile robots by including safety requirements in design activities. ISO 10218 includes (1) design requirements for safety, (2) specifications for architectures that support safe robot designs, (3) techniques for safe integration of robots into industrial systems safely, and (4) techniques for ongoing operation and maintenance of a cyber-physical system.

Now, returning to discussion of the stepwise flow of cyber-physical system method 2A00, and specifically referring to the context of step 206, it sometimes happens that the safety code 207 is drawn from a safety code library (based at least in part on safety requirements 204) and/or configured (based at least in part on safety requirements 204), and then integrated into the pre-existing cyber-physical system using any known technique. In this embodiment, merely as an example, step 208 invokes one or more access methods to integrate safety code into the emergency stop functionality of the cyber-physical system. The integrated safety code might be wholly within a module or modules that comprises second supervisory control layer 271₂, or the integrated safety code might be wholly within a module or modules that comprise first supervisory control layer 271₁, or the integrated safety code might span between first supervisory control layer 271₁ and second supervisory control layer 271₂. In any of the foregoing integration scenarios, control can move to step 210 whereafter the operations of the robot not only safely carry out operations of the modified cyber-physical system (step 210), but also safely respond to emergency stop situations by executing at least a portion of the safety code (step 212).

The foregoing discussion of FIG. 2A pertains to merely some possible embodiments and/or ways to integrate software code into a cyber-physical system. Many variations are possible, for example, the cyber-physical system as comprehended in the foregoing can be implemented using any type of operational components (e.g., semiconductor chips, state machines, etc.) and/or in any environment, one example of which possible embodiments is shown and described as pertains to FIG. 2B1.

FIG. 2B1 exemplifies a method for configuring electronic components of a cyber-physical system that includes a combination of hardware and software to achieve safe robotic responses to human-initiated emergency stops. As an option, one or more variations of integration mechanism 2B100 or any aspect thereof may be implemented in the context of the architecture and functionality of the embodiments described herein and/or in any environment.

The figure is being presented to illustrate how a cyber-physical system might be configured to implement a safety facility using electronic components. More specifically, the figure is being presented to illustrate how a system component manifest can be used by an integration mechanism to identify system components that provide access to emergency stop functionalities. More particularly, the figure is being presented to illustrate how add-on components can augment the functionality of pre-existing components so as to implement modified emergency stop functionalities.

Upon invocation of integration mechanism 2B100, step 222 serves to identify system components that are directly accessible (or that provide access to) emergency stop functionalities. In this particular embodiment, system component manifest 223 comprises add-on components 225 that can augment the functionality of pre-existing components 224. Integration of one or more add-on components 225 with pre-existing components 224 serves to augment the functionality of the pre-existing components so as to create modified emergency stop functionalities. Such integrations result in robot behavior (esp., in emergency stop situations) where commanded robot behavior is guaranteed to comport with safety requirements (e.g., safety requirements 204).

As shown, given a selected set of pre-existing components 224, a selected set of more add-on components 225, and given a set of safety requirements 204, step 226 serves to configure one or both of the selected set of pre-existing components and selected set of one or more add-on components. This configuration can involve, for example, configuring a semiconductor chip (step 226) and enabling such a configuration (step 228) in a manner that modifies the pre-existing emergency stop functionality so as to augment the functionality of the pre-existing components. The foregoing configuration step and/or enabling step might involve loading software into a volatile memory of the semiconductor chip and/or it might involve loading software into a non-volatile memory of the semiconductor chip, and/or it might involve making changes to microcode of the semiconductor chip.

In some cases, the configuration involves two operations, where a first operation performs modification of the selected set of pre-existing components 224 (and/or where the first operation performs modification of the selected set of add-on components 225), followed by a second operation that enables modification (and/or enabling for use) the pre-existing emergency stop functionality. Thereafter, the cyber-physical system can safely carry out operations within the bounds of the modified cyber-physical system (step 210). More specifically, the modified cyber-physical system can safely respond in emergency stop situations (step 210), such as when responding to a human-initiated emergency stop indication.

Further details regarding general approaches to implementing a cyber-physical system that can safely carry out operations within particularly-defined bounds are described in U.S. application Ser. No. 18/324,042 titled “SYSTEMS AND METHODS FOR HIGH-SPEED GEOFENCING” filed on May 25, 2023, which is hereby incorporated by reference in its entirety.

The foregoing discussion of FIG. 2B1 pertains to merely some possible embodiments and/or ways to implement electronic components (e.g., semiconductor chips) into a cyber-physical system. Many variations are possible, for example, the cyber-physical system as comprehended in the foregoing can be implemented using any types of operational components that receive input signals and transform or transduce such input signals into output signals that are delivered (e.g., via direct electrical connection, or via operation of a protocol) to motors and actuators of the cyber-physical system. Moreover, certain embodiments involve configuration of and/or modification of multiple electronic components (e.g., semiconductor chips) of a cyber-physical system so as to achieve safe robotic responses to human-initiated emergency stops.

FIG. 2B2 exemplifies use of integration mechanisms for configuring a cyber-physical system so as to achieve safe robotic responses to human-initiated emergency stops. As an option, one or more variations of cyber-physical system 2B200 or any aspect thereof may be implemented in the context of the architecture and functionality of the embodiments described herein and/or in any environment. The figure is being presented to illustrate integration mechanisms so as to integrate software code into or with a pre-existing system. Moreover, the figure is being presented to illustrate how the shown integration mechanisms can share semantics of various parameters that might be shared between aspects of a pre-existing system and aspects of an add-on emergency stop module.

As shown, step 242 identifies a set of integration mechanisms (e.g., from a dataset 257 comprising various integration mechanisms) that can thereafter be assessed in an outer loop 255. Any particular integration mechanism can have any number of access mechanisms 244. For example, an application programming interface 260 might have a first type of access mechanism (e.g., a registration call), whereas a protocol 262 might have a second type of access mechanism (e.g., a protocol preamble), and whereas a hardware accelerator 264 might have a third type of access mechanism (e.g., a power-up and initialization routine), etc.

In some cases, in spite of performing one or more operations that invoke or facilitate scanning the cyber-physical system to identify cyber-physical system components that implement at least some of the first collection of emergency stop functionalities, it can happen that no mechanisms for integrating add-on functionality turn up in spite of the scanning. That is, there are some systems where no particular mechanism for integrating adding-on functionality is (or can be) known a priori (i.e., before such time as first actions are taken to begin integration). In this situation, a list of system components of the cyber-physical system that implement at least some of the first collection of emergency stop functionalities is sought. Further, as a potential response to failing to identify such a list, a discovery scout 266 is deployed. Such a discovery scout is configured to interrogate the cyber-physical system to determine what integration mechanisms might be used to integrate all or portions of a second supervisory control layer in cooperation with the cyber-physical system's pre-existing first supervisory control layer. In some cases, the discovery scout might not turn up any particular integration mechanisms that can be used to implement the second supervisory control layer. In such cases, the cyber-physical system's pre-existing implementation in totality is considered to be the first supervisory control layer, and the second supervisory control layer is deemed to be an add-on to a first supervisory control layer having unknown or undefined functionality.

Now, inasmuch as the foregoing disclosure covers a range of integration mechanisms, and inasmuch as in-use behaviors accruing to either or each of the first supervisory control layer and the second supervisory control layer, it becomes apparent that there are (or needs to be) shared parameters. Moreover, the representation of shared parameters (e.g., codification of parameters in a manifest of parameters) as well as common semantics for sharing parameters and/or their values need to be agreed upon. Strictly as examples, parameters might refer to distances. In one case (e.g., within a first supervisory layer) a distance is codified in an integer number of millimeters, whereas in another case (e.g., within a second supervisory layer) a distance is codified as a floating-point number that expresses both an integer portion as well as a fractional portion (e.g., 1.01 would be a floating-point representation of 1 meter plus 1/100^{th} of a meter). Regardless of the choice of representation of a parameter and/or its value, the semantics of the parameter need to be normalized. Accordingly, once it is determined what parameters 248 can be shared using a particular integration mechanism (step 246), an inner loop 251 can handle normalization (step 250) as well as an initial exchange of parameter information (step 252).

As shown, the outer loop includes a test 243 to see if there are further aspects of the then-current mechanism, and if so, control is passed back to the top of the loop for further consideration. One of skill in the art will recognize that in the course of exchanging information about a particular parameter or other aspect of the access mechanism, it happens that a new parameter is created and/or determined to be sharable. The outer loop serves to handle such a case. Moreover, observance of the FOR EACH loop as well as the control steering aspect of the outer loop serves to ensure that the needed information (e.g., pertaining to shared parameters) has been considered prior to selecting an add-on capability and/or prior to making modification to enrich the operational capabilities of the add-on functionality (step 245).

The foregoing description pertaining to FIG. 2B1 and FIG. 1B2 pertain substantially to systems that include hardware (e.g., semiconductor chips). However, it often happens that modern cyber-physical systems include some mixture of hardware and software (e.g., chips and code). In fact, it often happens that some portions or aspects of E-stop functionality are deployed in hardware and other portions or aspects of an E-stop functionality are deployed in software. Such design trade-off possibilities are shown and discussed as pertains to the following figures.

FIG. 2C1, FIG. 2C2, and FIG. 2C3 are presented to illustrate different arrangements (e.g., partitions) of electronic components of a cyber-physical system. As an option, one or more variations of first cyber-physical system 2C100 and/or second cyber-physical system 2C200 and/or third cyber-physical system 2C300 or any aspect thereof may be implemented in the context of the architecture and functionality of the embodiments described herein and/or in any environment.

As shown, interactions between operational units of a cyber-physical system (e.g., interactions between supervisory layer 272 and command and control module 232) are defined in terms of signals 233_{FIRST}, which signals are intended to be implementation agnostic.

The three figures are being presented on the same sheet to illustrate how a given system (e.g., first cyber-physical system 2C100) might be configured into a modified and partitioned system (e.g., second cyber-physical system 2C200), or might be configured into a different modified and partitioned system (e.g., third cyber-physical system 2C300), then deployed to operate safely in any environment.

In the legacy partitioning of FIG. 2C1, motor and actuator command and control module communicates with a collection of motors and actuators 240 via signals 233. FIG. 2C2 depicts a technical advance involving safety facility 108 that operates in cooperation with actuator command and control module 232. More specifically, safety facility 108 is implemented as an operational layer that is situated between a motor and actuator command and control module 232 and a collection of motors and actuators 240. As shown, safety facility 108 includes a chip, some code, and a protocol. The motor and actuator command and control module 232 communicates signals 233_{FIRST} to safety facility 108, which interprets the given signals 233_{FIRST} and then modifies the given signals so as to emit signals 233_{SECOND}, which modification is taken so as to result in safe operation of the motors and actuators 240 when the cyber-physical system is being commanded using signals 233_{SECOND}.

As shown, the first supervisory control layer 271₁, is formed by supervisory layer 272 (e.g., a pre-existing supervisory layer), whereas the second supervisory control layer 271₂ is formed by safety facility 108. These are merely examples for illustration. Other partitionings are possible. Moreover, signaling between operational components of the cyber-physical system can involve unidirectional signaling and/or bidirectional signaling, or both. This is shown in the third cyber-physical system 2C300. More specifically, signals 233_{FIRST} are shown as being bidirectional, at least in the sense that, in some cases, signals 233_{FIRST} initially derive from the layers above (e.g., such as from supervisory layer 272 and/or from any operational element of first supervisory control layer 271₁). In certain other cases, signals 233_{FIRST} derive from the layers below (e.g., from motors and actuators 240).

FIG. 2D1 depicts a software integration technique for adding enhanced functionality that guarantees safe robotic responses to human-initiated emergency stops. As an option, one or more variations of software integration technique 2D100 or any aspect thereof may be implemented in the context of the architecture and functionality of the embodiments described herein and/or in any environment.

The figure depicts a detailed implementation of a robotic system stack, where each level of the stack communicates with at least one other level of the stack. The implementation includes an autonomy layer 270, a supervisory layer 272, and a safety guarantee layer 273_{SOFTWARE}. The implementation further includes an emergency stop module 259 that responds to various types of emergency stop orders (e.g., emergency stop order 211_{METHOD1} or emergency stop order 211_{METHOD2}, or emergency stop order 211_{METHOD3}) that arise in response to an act of a user (e.g., user 209), such as pressing a button, or performing a hand waving or other glyph or visually-discernable signal, etc. by quickly placing a cyber-physical system in a default, inert, low-power state comprising a default emergency response state. Upon receiving safety requirements that add to or modify the default emergency response state to provide a revised emergency response state, the emergency stop module is reconfigured to respond to an emergency stop order by quickly placing the cyber-physical system in the revised emergency response state.

As shown, the details of autonomy layer 270 include modules for information collection and processing (e.g., processing module 252₁, processing module 252₂, . . . , processing module 252_{N}), which modules collect information from a first set of various environmental condition sensors 278₁. The autonomy layer 270 is configured to receive mission-defining data structures 276, which are then transformed into signals comprising data (e.g., signal data 254) that initiates or directs a series of robotic operations that, in aggregate, achieve an assigned mission. Some of the aforementioned signal data is published (e.g., via signal data publisher module 256_{AUTONOMY}) into a time-ordered signal data queue array 258, which is an array of queues, each of which queues include timestamped signal data (e.g., signal S₁₁, signal S₁₂, signal S₁₃; signal S₂₁, signal S₂₂, signal S₂₃; . . . , signal S_{N1}, signal S_{N2}, signal S_{N3}, etc.). Signal data from these queues is accessed by supervisory layer 272, which receives information from environmental condition sensors 278₂, and in turn provides modularized functions including those functions provided by a signal intercept module 261, a signal modification module 262, a signal data publisher module 256_{SAFETY} and an emergency stop module 259. It should be noted that the foregoing E-stop modules include sub-constituents: a first set of components that implement default E-stop operations (e.g., default ops 263) and a second set of components that implement modified E-stop operations (e.g., modified ops 265). The default E-stop operations are those provided by an unmodified cyber-system (not shown), whereas the modified E-stop operations are those provided by the add-on capabilities disclosed herein.

As can be understood, an E-stop module is able to respond to an emergency stop order that arises from any known method. In particular, the E-stop module 259 as shown is able to respond to an emergency stop order that arises from either a preconfigured E-stop order (e.g., emergency stop order 211_{METHOD1}) and/or the E-stop module 259 is able to respond to an emergency stop order that arises from an in-situ real time E-stop order (e.g., emergency stop order 211_{METHOD2} arising from user 209). In some cases, emergency stop operations are defined by software that are included in a supervisory layer (such as is shown in FIG. 2D1), whereas in other cases, emergency stop operations are defined by software that is resident in modules that are part of a safety guarantee layer (e.g., safety guarantee layer 273_{SOFTWARE}, as shown). Regardless of where the emergency stop operations are defined, and/or regardless of how E-stop behavior override signals 267 are created, they (i.e., operations and/or signals) are presentable to, and often executed by, one or more robotic control modules (e.g., robotic control module 266₁, robotic control module 266₂, . . . , robotic control module 266_{N}), which in turn avail of actuators 268 and motors 269 so as to carry out the kinetic operations in the physical world.

The foregoing discussion of FIG. 2D1 pertains to merely some possible embodiments and/or ways to implement a software integration technique for adding enhanced functionality that guarantees safe robotic responses to human-initiated emergency stops. Many variations are possible, for example, the software integration technique as comprehended in the figure can be augmented to include integration of hardware, for example a semiconductor chip. An example of such an augmentation is shown and described as pertains to the following figure.

FIG. 2D2 depicts a hardware integration technique for adding enhanced functionality that guarantees safe robotic responses to human-initiated emergency stops. As an option, one or more variations of hardware integration technique 2D200 or any aspect thereof may be implemented in the context of the architecture and functionality of the embodiments described herein and/or in any environment.

The figure depicts a detailed implementation of a robotic system stack, where each level of the stack communicates with at least one other level of the stack. The implementation is similar to the foregoing FIG. 2D1, however notably, the integration involves deployment of a chip that interfaces (directly or indirectly) between e-stop module 259 and any/all of the robotic control modules (e.g., robotic control module 266₁, robotic control module 266₂, . . . , robotic control module 266_{N}). In this embodiment, emergency stop operations are defined by hardware that is included in a supervisory layer such as is shown by safety guarantee layer 273_{HARDWARE}.

The additional hardware of the shown safety guarantee layer 273_{HARDWARE}, possibly including some or all of the functions of the chip, serve to intercept and (in some cases) override defaults ops 263. In some cases, the hardware generates signals identical to or similar to the E-stop behavior override signals 267 of FIG. 2D1. Such signals are presented to, and often executed by, one or more robotic control modules.

### Additional Embodiments of the Disclosure

### Instruction Code Examples

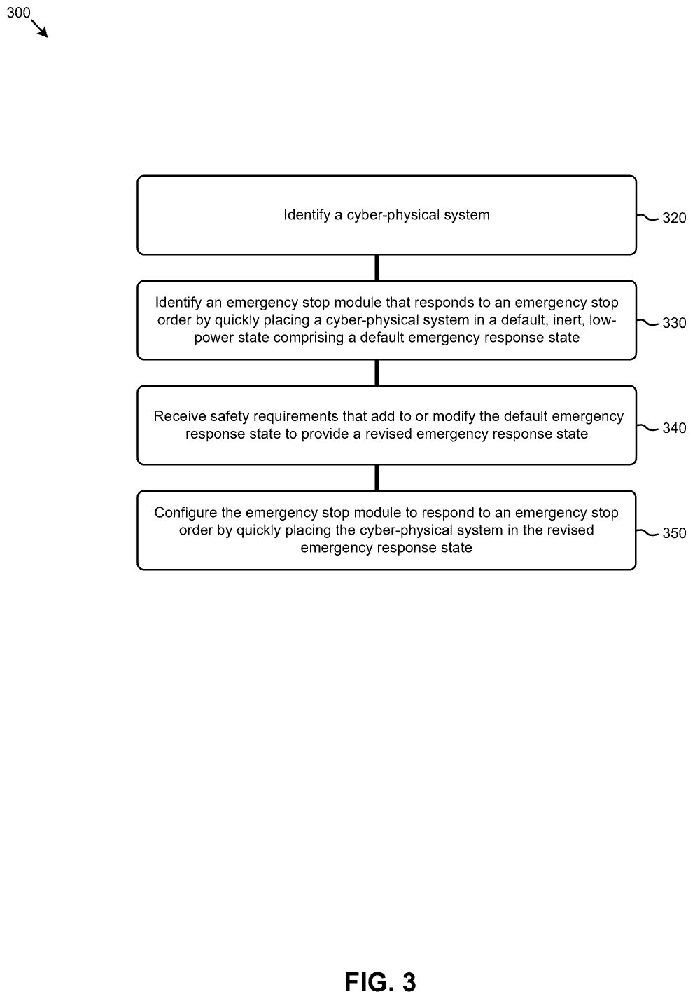

FIG. 3 depicts system 300 as an arrangement of computing modules that are interconnected so as to operate cooperatively to implement certain of the herein-disclosed embodiments. This and other embodiments present particular arrangements of elements that, individually or as combined, serve to form improved technological processes that address undefined or dangerous robotic responses to human-initiated emergency stops. The partitioning of system 300 is merely illustrative and other partitions are possible.

FIG. 3 depicts a block diagram of a system to perform certain functions of a computer system. As an option, system 300 may be implemented in the context of the architecture and functionality of the embodiments described herein. Of course, however, the system 300 or any operation therein may be carried out in any desired environment.

The system 300 comprises at least one processor and at least one memory, the memory serving to store program instructions corresponding to the operations of the system. As shown, an operation can be implemented in whole or in part using program instructions accessible by a module. The modules are connected to a communication path. The modules of the system can, individually or in combination, perform method operations within system 300. Any operations performed within system 300 may be performed in any order unless as may be specified in the claims.

The shown embodiment performs steps that: identify a cyber-physical system (module 320); identify an emergency stop module that responds to an emergency stop order (from a user, pressing a button, for example) by quickly placing a cyber-physical system in a default (or currently configured) inert, low-power state comprising a default emergency response state (module 330); receive safety requirements that add to or modify the default emergency response state to provide a revised emergency response state (module 340); and configure the emergency stop module to respond to an emergency stop order by quickly placing the cyber-physical system in the revised emergency response state (module 350).

The foregoing safety requirements and/or the foregoing revised emergency response state may refer to a range of motion, or a speed of motion, or a pressure limitation or any other sort of force-related and/or speed/timing-related constraint.

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

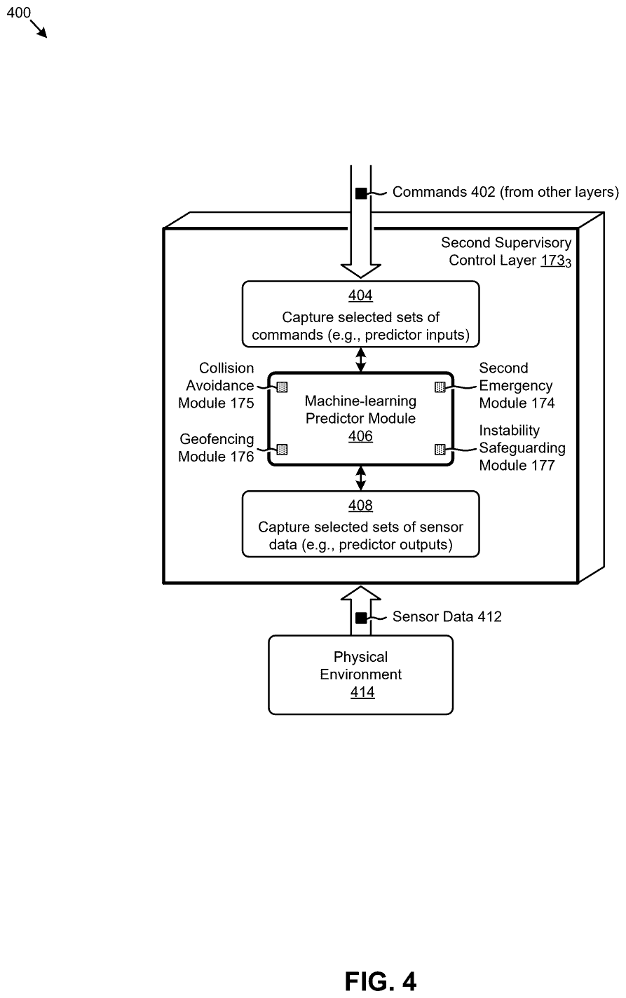

FIG. 4 depicts a system 400 as arrangements of computing modules that are interconnected so as to implement a second supervisory control layer 173₃ having a machine-learning predictor module. As shown, the machine-learning predictor module 406 is populated with a predictor inputs (step 404) in the form of commands 402 that arise from other layers. Also as shown, the machine-learning predictor module 406 is populated with predictor outputs (step 408). As is known in the art, a set of outputs of a predictor can arise from stimulus of a trained predictor, where such stimulus is a collection of then-current parameters which may include sensor data 412, sets of observed conditions, sets of environmental data, etc., and where the raised outputs correlate in one machine-learned manner or another to sets of trained-in parameters, which may in turn have been drawn from or derived from parameters of physical environment 414. Such raised outputs can be grouped in a manner such that the predictor module can be used for many purposes, including for collision avoidance (e.g., based on learned successful avoidance), and/or based on reinforcement learning (e.g., based on some combination of learned successful avoidance and contrived avoidance failures). Similarly, predictor outputs can be used in the context of geofencing, and/or for safeguarding against instabilities.

The machine learning techniques as heretofore described, and in particular any known-good and known-bad emergency stop behaviors can be loaded into a predicting model by virtue of operating the cyber-physical system in a controlled prototyping environment (e.g., corresponding to a supervised learning situation) where even known bad behaviors (e.g., unsafe behaviors that can be useful in reinforcement learning scenarios) can be carried out without damage to the cyber-physical system and/or its surroundings. As such, the first law of robotics is not violated.

### System Architecture Overview

### Additional System Architecture Examples

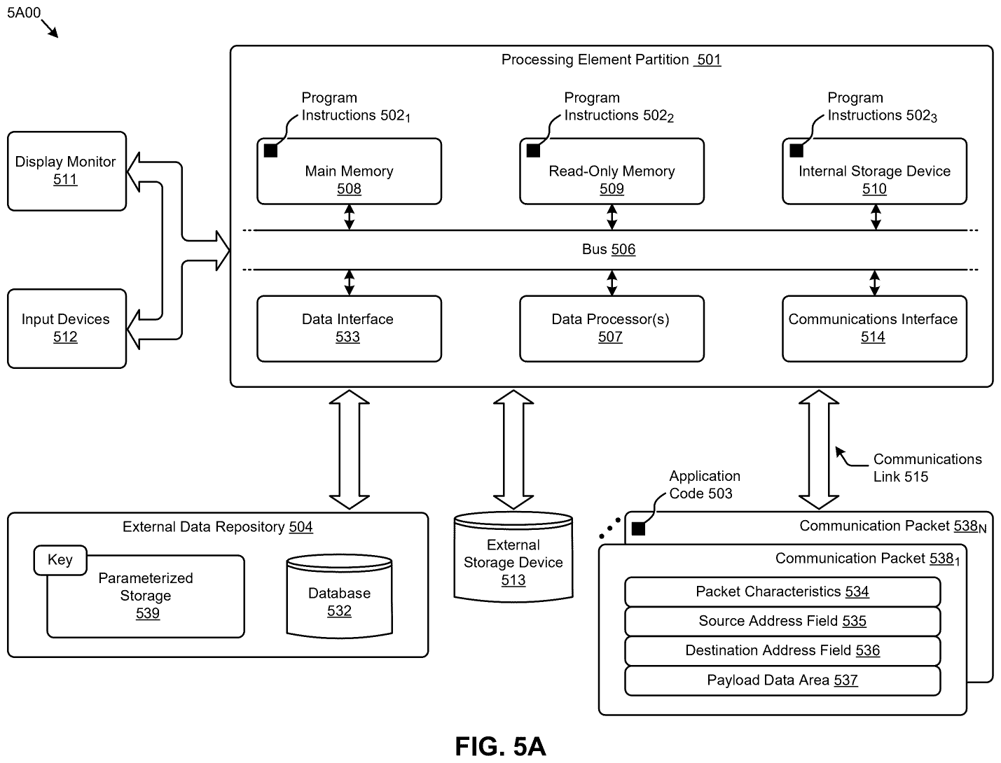

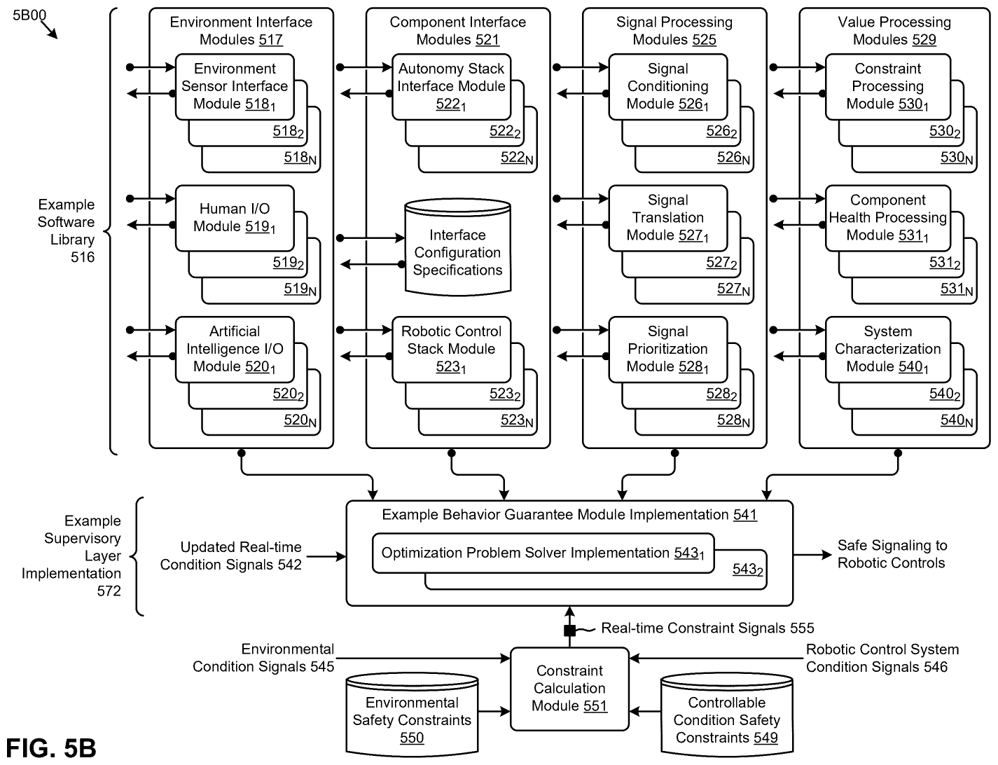

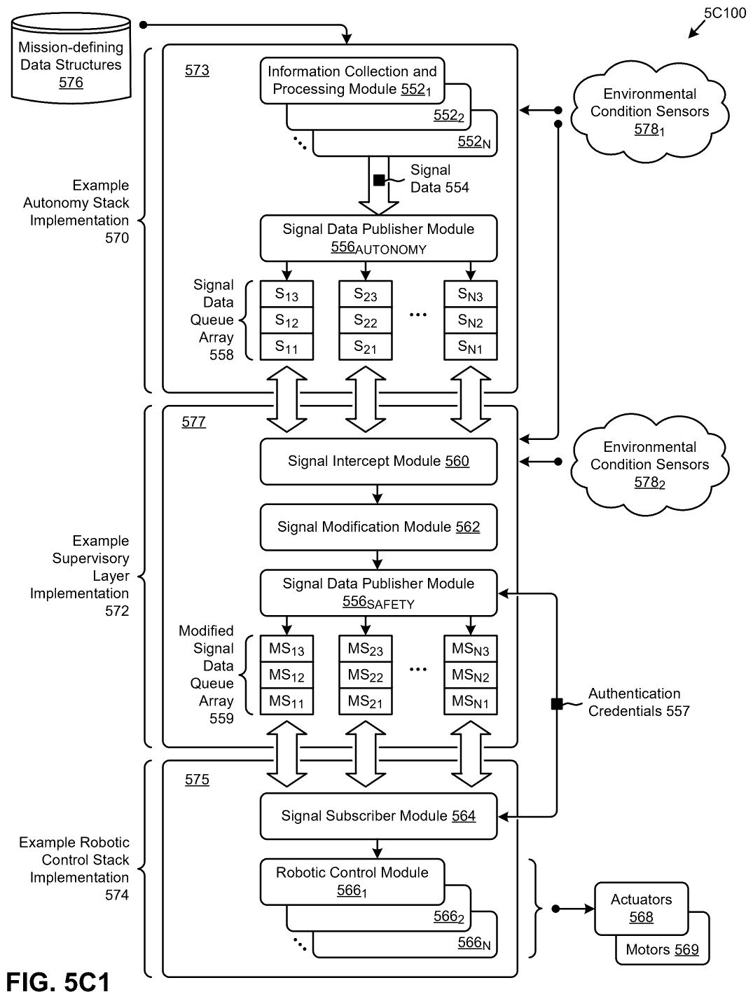

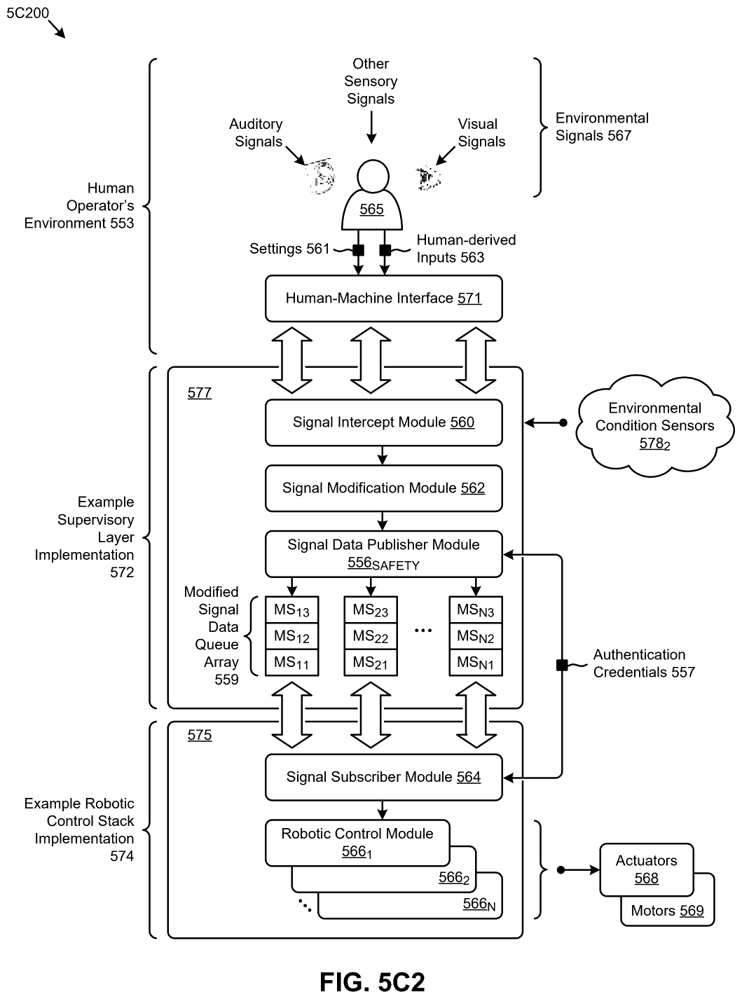

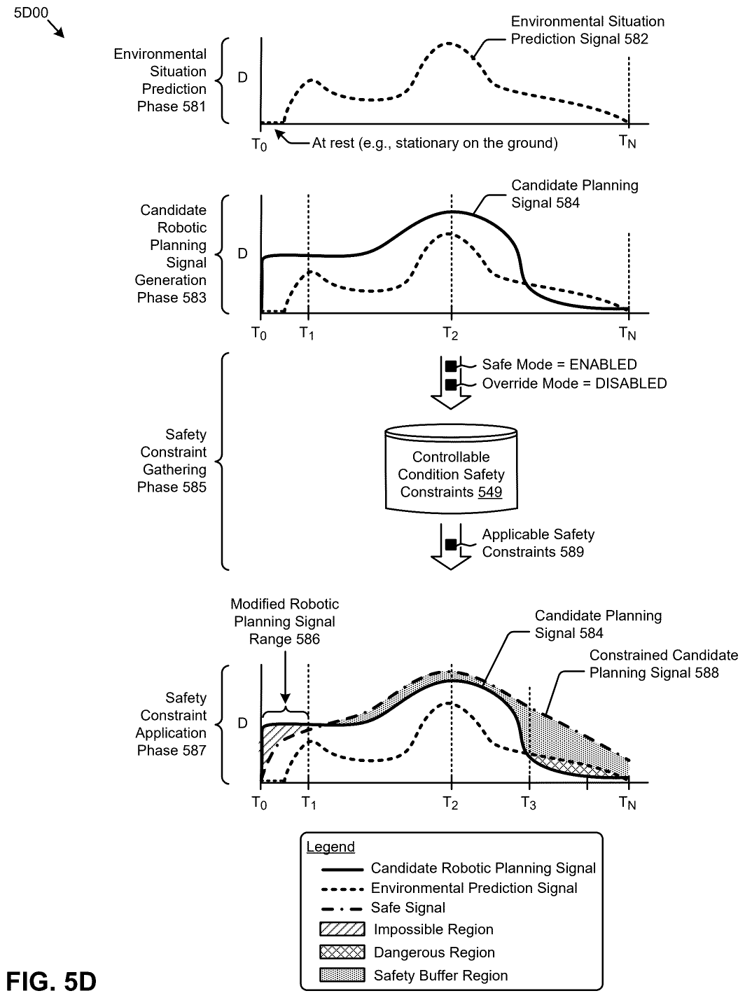

FIG. 5A depicts a block diagram of an instance of a computer system suitable for implementing embodiments of the present disclosure. Computer system 5A00 includes a bus 506 or other communication mechanism for communicating information. The bus interconnects subsystems and devices such as a central processing unit (CPU) or a multi-core CPU (e.g., data processor 507), a system memory (e.g., main memory 508 or an area of random access memory (RAM)), a non-volatile storage device or non-volatile storage area (e.g., read-only memory 509), a storage device that uses semiconductor memory or magnetic or optical technologies (e.g., internal storage device 510), a data interface 533, and a communications interface 514 (e.g., PHY, MAC, Ethernet interface, modem, etc.). The aforementioned components are shown within processing element partition 501, however other partitions are possible. Computer system 5A00 further comprises a display 511 (e.g., CRT or LCD), various input devices 512 (e.g., keyboard, cursor control, etc.), and an external data repository 504.

According to some embodiments of the disclosure, computer system 5A00 performs specific operations by data processor 507 executing one or more sequences of one or more program instructions contained in a memory. Such instructions (e.g., program instructions 502₁, program instructions 502₂, program instructions 502₃, etc.) can be contained in, or can be read into, a storage location or memory from any computer readable/usable storage medium such as a static storage device or a disk drive. The sequences can be organized to be accessed by one or more processing entities configured to execute a single process or the sequences can be configured for execution by multiple concurrently running processing entities. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 5A00 performs specific networking operations using one or more instances of communications interface 514. Instances of communications interface 514 may comprise one or more networking ports that are configurable (e.g., pertaining to speed, protocol, physical layer characteristics, media access characteristics, etc.), and any particular instance of communications interface 514 or port thereto can be configured differently from any other particular instance or port. Portions of a communications protocol can be carried out in whole or in part by any instance of communications interface 514, and data (e.g., packets, data structures, bit fields, etc.) can be positioned in storage locations within communications interface 514 or within system memory, and such data can be accessed (e.g., using random access addressing, or using direct memory access (DMA), etc.) by devices such as data processor 507.

Communications link 515 can be configured to transmit (e.g., send, receive, signal, etc.) any type of communications packets (e.g., communication packet 538₁, . . . , communication packet 538_{N}) comprising any organization of data items. The data items can comprise a payload data area 537, a destination address field 536 (e.g., a destination IP address), a source address field 535 (e.g., a source IP address), and can include various encodings or formatting of bit fields to populate packet characteristics 534. In some cases, the packet characteristics include a version identifier, a packet or payload length, a traffic class, a flow label, etc. In some cases, payload data area 537 can comprise a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software (e.g., instructions stored in/on a non-volatile medium), or hardware that is used to implement all or part of the disclosure.

The terms “computer readable medium” or “computer usable medium” as used herein refer to any medium that participates in providing instructions to data processor 507 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, a flash memory drive, a spinning hard drive, a floppy disk, a flexible disk, magnetic tape, or any other magnetic medium; a CD-ROM or any other optical medium such as punch cards, paper tape, or any other physical medium with patterns of holes; semiconductor memories such as RAM, PROM, EPROM, FLASH-EPROM, or any other memory chip or cartridge; or any other non-transitory computer readable medium. Such data can be stored, for example, in the shown external storage device 513, and/or in any form of an external data repository 504, either of which can be formatted into any one or more storage areas. Certain forms of computer readable media comprise parameterized storage 539 accessible by a key (e.g., filename, table name, block address, offset address, etc.).

Execution of the sequences of instructions to practice certain embodiments of the disclosure are performed by a single instance of a computer system 5A00. According to certain embodiments of the disclosure, two or more instances of computer system 5A00 coupled by a communications link 515 (e.g., LAN, public switched telephone network, or wireless network) may perform the sequence of instructions required to practice embodiments of the disclosure using two or more instances of components of computer system 5A00.

Computer system 5A00 may transmit and receive messages such as data and/or instructions organized into a data structure (e.g., communications packets). The data structure can include program instructions (e.g., application code 503) communicated through communications link 515 and communications interface 514. Received program instructions may be executed by data processor 507 as they are received at the data processor. The program instructions can be copied any number of times (e.g., into an intermediate memory and/or into a CPU cache) for later execution.

Computer system 5A00 may communicate through a data interface 533 to a database 532. Data items in a database can be accessed using a primary key (e.g., a relational database primary key) and any number of secondary keys.

Processing element partition 501 is merely one sample partition. Other partitions can include multiple data processors and/or multiple communications interfaces and/or multiple storage devices, etc. within a partition. For example, a partition can bound a multi-core processor (e.g., possibly including embedded or co-located memory), or a partition can bound a computing entity having a plurality of computing elements, any of which computing elements are connected directly or indirectly to a communications link of any sort. Furthermore, a first partition can be configured to communicate to a second partition. A particular first partition and a particular second partition can be congruent (e.g., in a processing element array) or can be different (e.g., comprising disjoint sets of components). A partition can include a single module or a partition can include a plurality of modules.

As used herein, a module refers to any mix of any portions of system memory and any extent of hard-wired circuitry including hard-wired circuitry embodied as all or portions of a data processor 507, which data processor can be used to realize, with or without reliance on the system memory, all or portions of processor-implemented systems or subsystems. Some embodiments of a module include one or more special-purpose hardware components (e.g., sensors, transducers, power control, actuator control logic, etc.). Some embodiments of a module include instructions that are stored in a processor-accessible memory for execution so as to facilitate operational and/or performance characteristics pertaining to fitting a robotic system software stack to interface with an interstitial supervisory layer. A module may include one or more state machines and/or combinational logic used to implement or facilitate the operational and/or performance characteristics pertaining to fitting a robotic system software stack to interface with an interstitial supervisory layer.

Various implementations of database 532 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of fitting a robotic system software stack to interface with an interstitial supervisory layer). Such files, records, or data structures can be brought into and/or stored in volatile or non-volatile memory. The occurrence of, and organization of the foregoing files, records, and data structures improve the way in which the computer stores and retrieves data in memory so as to implement all or portions of a robotic system stack. Strictly as one example, various of the disclosed embodiments improve the way data is accessed when the computer is performing operations pertaining to fitting a robotic system software stack to integrate with an interstitial supervisory layer, and/or for improving the way data is manipulated when performing computerized operations pertaining to robot behavior.

FIG. 5B depicts an environment in which a behavior guarantee module can be implemented. As shown, environment 5B00 includes an example software library 516. Such a library can be situated in a development environment or such a library, either in whole or in part, can be deployed to the field for dynamic linking and loading. Strictly as one example, various components from such a software library can be interfaced together to form variations of a behavior guarantee module. Strictly as an illustration, a behavior guarantee module (e.g., example behavior guarantee module implementation 541) can be constructed of one or more environment interface modules 517, one or more component interface modules 521, one or more signal processing modules 525, and/or any one or more value processing modules 529. The foregoing environment interface modules, component interface modules, signal processing modules, and value processing modules are discussed in further detail hereunder.

As shown, environment interface modules 517 include a selectable set of environment sensor interface modules (e.g., environment sensor interface module 518₁, environment sensor interface module 518₂, . . . , environment sensor interface module 518_{N}; human I/O module 519₁, human I/O module 519₂, . . . , human I/O module 519_{N}; and artificial intelligence I/O module 520₁, artificial intelligence I/O module 520₂, . . . , artificial intelligence I/O module 520_{N}). Any of the foregoing constituents of the environment interface modules can be configured for any particular application. Any combination of environment interface modules can be juxtaposed in any topology and/or in any order or organization.

As shown, component interface modules 521 include a selectable set of component sensor modules (e.g., autonomy stack interface module 522₁, autonomy stack interface module interface module 522₂, . . . , autonomy stack interface module 522_{N}; and robotic control stack module 523₁, robotic control stack module 523₂, . . . , robotic control stack module 523_{N}). Any of the foregoing constituents of the component interface modules can be configured for any particular application. The component interface modules may further include a database or other storage of interface configuration specifications. Any combination of component interface modules can be juxtaposed in any manner.

As shown, signal processing modules 525 include a selectable set of various signal processing modules (e.g., signal conditioning module 526₁, signal conditioning module 526₂, . . . , signal conditioning module 526_{N}; signal translation module 527₁, signal translation module 527₂, . . . , signal translation module 527_{N}; and signal prioritization module 528₁, signal prioritization module 528₂, . . . , signal prioritization module 528_{N}). Any of the foregoing constituents of the signal processing modules can be configured for any particular application. Any combination of signal processing modules can be juxtaposed into any organization.

As shown, value processing modules 529 include a selectable set of various value processing modules (e.g., constraint processing module 530₁, constraint processing module 530₂, . . . , constraint processing module 530_{N}; component health processing module 531₁, component health processing module 531₂, . . . , component health processing module 531_{N}; and system characterization module 540₁, system characterization module 540₂, . . . system characterization module 540_{N}). Any of the foregoing constituents of the value processing modules can be configured for any particular application. Any combination of value processing modules can be juxtaposed into any organization. Moreover, in some settings, any of the foregoing modules and specifications can be included (or excluded) in any particular deployment.

The particular deployment shown includes an example supervisory layer implementation 572. Such a supervisory layer may include one or more implementations of a behavior guarantee module (e.g., the shown example behavior guarantee module implementation), which in turn may include one or more optimization problem solver (e.g., optimization problem solver implementation 543₁, and optimization problem solver implementation 543₂). A behavior guarantee module can be configured with any manner of environment interface modules, which in turn are configured to be able receive an ongoing stream of updated real-time condition signals 542. Those updated real-time condition signals can be combined with an ongoing stream of real-time constraint signals 555 to express a then-current safe operation requirement into codification that is in a form of a problem that can be solved by one or more optimization problem solvers.

The ongoing stream of real-time constraint signals 555 can derive from any combination of environmental safety constraints 550 and/or any combination of controllable condition safety constraints 549. In some cases, the ongoing stream of real-time constraint signals is output from a constraint calculation module 551. Such a constraint calculation module can be configured to process any combination of environmental condition signals 545 and/or any combination of robotic control system condition signals 546.

In many cases environmental condition signals can change in response to signals that are sent to the robotic controls. For example, consider the scenario where there is an obstacle (e.g., a stationary object or a moving object) on the trajectory or path of a movable mechanical device (e.g., a robotic manipulator, an autonomous robotic vehicle, an autonomous aerial drone, etc.). Supposing that the controllable condition safety constraints include a constraint that has the semantics of “stay at least 10 feet from any obstacle,” then the path of the movable mechanical device can be changed so as to “veer away” from the obstacle. Once the movable mechanical device has maneuvered away, the newly updated environmental condition signals might indicate that there is no longer an obstacle in the path (or close to the path) of the movable mechanical device. Now, further consider that the “veer away”action was taken because of the aforementioned environmental safety constraint. However, it might be that there is a currently in force controllable condition safety constraint 549 that has the semantics of “stay at least 20 feet from any obstacle,” in which case, when considering both the environmental safety constraints as well as the controllable condition safety condition constraints, the constraint calculation module might form a real-time constraint signal that is more restrictive (e.g., safer) than when considering environmental safety constraints alone.

In exemplary scenarios, real-time candidate robotic planning signals are considered with respect to real-time constraints (e.g., environmental safety constraints, controllable condition safety constraints, etc.) so as to produce safe real-time signals, which are then provided to various robotic control systems. More particularly, candidate robotic planning signals corresponding to a robotic operation or a manipulator movement, or a robotic vehicle maneuver can be modified in accordance with the foregoing techniques so as to generate real-time robotic control signals that are deemed to be safe.

Further details regarding general approaches to producing safe robotic vehicle maneuvers are described in U.S. application Ser. No. 18/324,042 titled “SYSTEMS AND METHODS FOR HIGH-SPEED GEOFENCING” filed on May 25, 2023, which is hereby incorporated by reference in its entirety.

There may be many other scenarios and many other types of environmental safety constraints 550 as well as many other types of controllable condition safety constraints 549. For example, it can happen that a particular controllable condition safety constraint might be less constraining than a corresponding environmental safety constraint. The optimization problem solvers would solve for optimal solutions that still satisfy the then-current safety constraints. As such, it can happen that optimal safe robotic behavior is not necessarily any less optimal in any regard than optimal robotic behavior even in the absence of any given controllable condition safety constraints. On the other hand, it frequently happens that observance of controllable condition safety constraints overrides mere environmental safety constraints so as to result in safe behavior of the robot.

The supervisory layer implementation of FIG. 5B is merely one example as is applicable to the shown example environment. A supervisory layer can be implemented in many alternative environments, some of which such alternative environments are shown and described as pertains to FIG. 5C1 and FIG. 5C2.

FIG. 5C1 depicts a block diagram of an interstitially situated supervisory layer. More specifically, FIG. 5C1 depicts block diagram 5C100 that includes a safety module 577 (e.g., comprising example supervisory layer implementation 572) that is situated between a planning module 573 (e.g., comprising example autonomy stack implementation 570) and a kinetic control module 575 (e.g., comprising example robotic control stack implementation 574).

In this juxtaposition, the example supervisory layer implementation can be configured to (1) intercept signals from the example autonomy stack implementation, (2) process such intercepted signals, and (3) provide modified versions of the intercepted signals to downstream processing. Additionally or alternatively, the example supervisory layer implementation 572 can be configured to receive and process signals from any one or more of a variety of environmental sources (e.g., from environmental condition sensors 578₁ and/or from environmental condition sensors 578₂).

In this illustrative example, downstream processing includes processing of the modified versions of the intercepted signals (e.g., by robotic control module 566₁, robotic control module 566₂, . . . , robotic control module 566_{N}) so as to provide signals to any of a plurality of motors 569 and/or actuators 568.

In this manner, the interstitially situated supervisory layer can support any one or more robotic control applications in various settings (e.g., involving robotic terrestrial vehicle control, manufacturing floor robot control, unmanned aerial vehicle control, and/or anthropomorphic robot control, etc.). In this particular architecture, example supervisory layer implementation 572 includes a signal intercept module 560, a signal modification module 562, and a signal data publisher module 556_{SAFETY}. The signal data publisher module 556_{SAFETY} is configured to enter modified versions of the intercepted signals (or portions thereof) into one or more modified signal queues, as exemplified by modified signal data queue array 559. As shown, the contents of the constituent queues of the modified signal data queue array (e.g., modified signal data queue entry MS₁₁, modified signal data queue entry MS₁₂, modified signal data queue entry MS₁₃, modified signal data queue entry MS₂₁, modified signal data queue entry MS₂₂, modified signal data queue entry MS₂₃, . . . , modified signal data queue entry MS_{N1}, modified signal data queue entry MS_{N2}, modified signal data queue entry MS_{N3}) are made accessible to downstream processing. Strictly as one possible implementation, access to the contents of the constituent queues of the modified signal data queue array is facilitated by one or more subscriber modules. The shown example is security hardened by virtue of the communication protocol between shown signal subscriber module 564 and signal data publisher module 556_{SAFETY}, where such a communication protocol serves to securely communicate information (e.g., authentication credentials 557) between the modules.

The shown example robotic control stack implementation 574 includes a signal subscriber module, shown as signal subscriber module 564, which signal subscriber module can be configured to access entries that are stored in any one or more queues of the modified signal data queue array 559. In some cases, a signal subscriber module can be configured to access entries according to a first-in-first-out (FIFO) regime, and/or a signal subscriber module can be configured to access entries according to a last-in-first-out (LIFO) regime, and/or a signal subscriber module can be configured to access entries according to a random access regime, in which random access regime a subscriber can access entries from any position of any one or more queues of the modified signal data queue array.

Variations of the shown supervisory layer can be deployed in any environment that corresponds to any particular mission. Merely to illustrate one possible implementation, the environment of FIG. 5C1 includes a repository of mission-defining data structures 576. Particular types of data that might be populated into the foregoing mission-defining data structures may serve to inform various respective information collection and processing modules of an autonomy stack (e.g., information collection and processing module 552₁, information collection and processing module 552₂, . . . , information collection and processing module 552_{N}).

These information collection and processing modules take in information from the environment (e.g., via environmental condition sensors 578₁) and process such environmental information in conjunction with data of the of mission-defining data structures so as to produce processed information in the form of signal data 554, which processed information is made available for publication to and access by any types of subscribers. As shown, a signal data publisher module 556_{AUTONOMY} is interfaced with signal data queue array 558 to provide access to signal data (e.g., as may be present in signal queue entry S₁₁, signal data queue entry S₁₂, signal data queue entry S₁₃, signal data queue entry S₂₁, signal data queue entry S₂₂, signal data queue entry S₂₃, and signal data queue entry S_{N1}, signal data queue entry S_{N2}, . . . , signal data queue entry S_{N3}). Any signal data queue entry within the individual constituent queues of the signal data queue array 558 are accessible by signal intercept module 560. For security purposes, signal intercept module 560 may interact with signal data publisher module 556_{AUTONOMY} so as to establish authenticated and secure access to the content of the signal data queue array.

The foregoing example of FIG. 5C1 exemplifies an embodiment where the autonomy stack or its constituent autonomy agents publish signal data in a manner that the supervisory layer can intercept and process such signals. However there are situations where, rather than having an autonomy stack that generates signals destined for the robotic control stack, instead, a human operator generates signals destined for the robotic control stack. In similar fashion to how an interstitially situated supervisory layer can generate safe robotic control signals based on instructions from an autonomy stack, some embodiments generate safe robotic control signals based on instructions from a human operator. One example embodiment involving generating safe robotic control signals based on instructions from a human operator is shown and described as pertains to FIG. 5C2.

FIG. 5C2 depicts a block diagram involving a human operator's safe manipulation of a robotic control system. More specifically, FIG. 5C2 depicts block diagram 5C200 that includes an example supervisory layer implementation 572 that is situated between an example human operators'environment 553 and an example robotic control stack implementation 574.

This figure is being presented to illustrate how a supervisory layer can produce safe robotic control system signals based on signals received from a human operator. In this particular example, operator 565 uses his or her senses to process any of a variety of environmental signals 567. As shown, the user processes visual signals, auditory signals and other sensory signals, and then, using human faculties, resolves such sensory signals into man-machine interface inputs. The shown human-machine interface 571 can accept any manner of real-time inputs (e.g., human-derived inputs 563) as well as any manner of settings 561 that the user establishes. In some cases, a particular instance of a human-machine interface receives information from a robotic control stack, which information can be used to calibrate the human-machine interface. Such calibration can take place statically (e.g., when the user is not actively providing human-derived signals to the human-machine interface), or such calibration can take place dynamically (e.g., during time periods when the user is actively providing human-derived signals to the human-machine interface).

As is known by those of ordinary skill in the art, a human operator can be a system's “own worst enemy.” That is, given a set of controls, and in absence of any modules that constrain or otherwise modify human inputs, a human operator, in spite of any amount of training and scenario simulation practice, can operate a robot in an unsafe manner. This of course is to be avoided. The foregoing supervisory layer serves to constrain or otherwise modify human inputs so as to guarantee safe operations with respect to all known environmental conditions. Strictly as one example, a supervisory layer can generate safe signals that govern speed of a manipulation and/or a supervisory layer can generate safe signals that govern the path taken (and safe space buffer required) by any articulation of the robot. There are many ways to implement safe signal generation and governance of a robotic system. On possible approach is shown and described as pertains to FIG. 5D.

FIG. 5D depicts a safe signal generation technique. The safe signal generation technique 5D00 is shown as a progression through several phases. In a first phase (e.g., the shown environmental situation prediction phase 581), an environmental situation prediction signal 582 is generated. In this example, the environmental situation prediction signal ranges from time=T₀ to time=T_{N}. The ordinate corresponds to the distance D that a robot is, or is predicted to be, from the nearest environmental features (e.g., the ground or obstacles that might be in the robot's path). In this particular scenario, the robot is initially at rest on the ground, traverses through a path, and comes again to a resting point on the ground.

In a second phase (e.g., the shown candidate robotic planning signal generation phase 583), a candidate planning signal 584 is generated. This candidate planning signal corresponds to the real-time signals that would need to be provided to the robotic control system in order to carry out a robotic operation or maneuver. In the illustrative example, the candidate planning signal already has some headroom or margin of error. Specifically, the candidate planning signal 584 corresponds to controlling the robot to maintain an even greater distance away from obstacles in the environment as was predicted in the environmental situation prediction phase 581. This is evident in the plot in that the candidate planning signal is plotted as maintaining an even greater distance away from any obstacle than is plotted by the environmental prediction signal. A candidate planning signal 584 may have within its range any number of local maxima and/or other types of critical points. In the shown example, there is a local maximum at time=T₁ and another local maximum at time=T₂.

After a candidate planning signal has been generated, possibly under control of an autonomy stack, the safe signal generation technique proceeds to a third phase (e.g., the shown safety constraint gathering phase 585) in which phase various safety constraints are gathered (e.g., from the shown controllable condition safety constraints 549). The specific constraints that are gathered (e.g., applicable safety constraints 589) may depend on whether or not a safe mode indication is enabled and/or whether an override mode indication is enabled, and may further depend on—and correspond to—any one or more of the then-current conditions. For example, if the currently under consideration maneuver requires movement through three dimensional space, then safety constraints corresponding to an X direction as well as safety constraints corresponding to a Y direction as well as safety constraints corresponding to a Z direction are gathered. Furthermore, in this safety constraint gathering phase, constraints pertaining to the mechanisms of the robotic control system are also gathered for potential use in the safety constraint application phase 587.

In most situations, accomplishment of some particular robotic maneuver involves control of actuators and/or control of motors. The operational characteristics of such actuators and/or motors is to be considered in the context of safety constraints. More specifically, application of any set of gathered safety constraints should not result in exceeding the operational capabilities of the robotic control mechanisms (e.g., actuators and/or motors). As an example, one way to avoid an obstacle is to “quickly maneuver” away from the obstacle when approaching it. However, in real robotic systems involving real motors and real actuators, operations intended to “quickly maneuver” are limited by characteristics that are designed into or inherent in the underlying robotic control system. Knowledge of such limitations are often pertinent to safe operation. To further explain, one way to “quickly maneuver” away from the obstacle so as to avoid a collision is to apply a great deal of acceleration in one or more directions that maneuver around or away from the obstacle. However, the amount of force needed to “quickly maneuver” might exceed the capabilities of the robotic control system. As such, safe operation needs to consider the limitations of the robotic control system when applying constraints.

After gathering applicable safety constraints in the safety constraint gathering phase 585, those gathered constraints can be applied. This is shown in FIG. 5D as a fourth phase, namely safety constraint application phase 587. In this phase, wrong or dangerous or practicably impossible robotic control signals are modified so as to operate within a safe robotic control regime. As can be seen, the transformation of the candidate planning signal 584 into the shown constrained candidate planning signal 588 serves to address any portions of the candidate planning signal 584 that were wrong or dangerous or practicably impossible, or otherwise unsafe. In the example signal transformation of FIG. 5D, the safe robotic control signal has some portions (e.g., within the impossible region) where the values in those portions correspond to lesser values than respective portions of the corresponding candidate planning signal (e.g., the portions as shown in the range of time=T₀ to time=T₁). Further, in the example signal transformation of FIG. 5D, the safe robotic control signal has some portions where the values in those portions correspond to higher values than respective points of the corresponding candidate planning signal (e.g., as shown in the range time=T₁ to time=T_{N}). In the example signal transformation of FIG. 5D, the safe robotic control signal has some portions where the values in those portions correspond to values that correct errors in respective points of the corresponding candidate planning signal (e.g., as shown in the range from time=T₃ to time=T_{N}).

In some cases, a particular incoming candidate planning signal is deemed to be safe even as unmodified (e.g., when the particular incoming candidate planning signal satisfies all applicable constraints). In other cases, a particular incoming candidate planning signal would need to be modified in order to be safe. In this latter case, any number of points and/or any number of ranges of points along the particular incoming candidate planning signal are modified to satisfy all applicable constraints. In the example shown, a particular range of points along the candidate planning signal 584, shown here as modified robotic planning signal range 586, are modified so as to send a ramped control signal (e.g., ramped during the time period from time=T₀ and time=T₁) to the robotic control system, rather than to apply an impulse signal to the robotic control system.

Of course the foregoing illustrates merely one type of situation. Other situations abound where some aspect of, or information from, the robotic control stack is used to inform how a candidate planning signal should be modified in order to produce a safe robotic control signal.

The foregoing techniques for guaranteeing safe behavior can be implemented in any environment and/or in any robotic system and/or in any deployment scenario. As a first example scenario, consider the situation where a first vehicle is approaching a second vehicle (e.g., in a speed/distance scenario where the first vehicle is a few seconds away from rear-ending the second vehicle. Now, assume unskilled driving where the driver accidentally presses the accelerator rather than the brake. In this situation, one or more safe behavior guarantee modules had prospectively characterized exactly how quickly the car is able to decelerate including consideration of characteristics of the vehicle's braking system, characteristics of the road, consideration of characteristics such as the weight of the vehicle and driver, as well as consideration of how much distance is covered during a braking maneuver. The one or more safe behavior guarantee modules calculates and actuates safe signals such that prior to a collision, the safe signals cause the first vehicle to decelerate (e.g., by applying brakes) on behalf of the driver. As a second example scenario, consider the situation where a robotic arm is repositioning a mechanical member from one position to another position. During the repositioning, a human being walks into the general proximity of the robotic arm. This presents a dangerous condition for the human being. As such, one or more safe behavior guarantee modules are configured to calculate safe parameters based on (1) the velocity (path and speed) of the human walking towards the robotic arm, as well as (2) how quickly the robotic arm can decelerate and stop.

The one or more safe behavior guarantee modules use both pieces of information to intercept any unsafe reference signals that were intended to be sent to the robotic arm's actuators and motors. In addition to merely intercepting unsafe signals before they are sent to the robotic arm's actuators and motors, calculated signals are sent to the robotic arm's actuators and motors. As a third example scenario, consider the situation where a semi-autonomous mobile robot is moving around a factory floor. A maximum speed parameter indicates that the mobile robot is limited to less than 2 m/s speed. Now, if the operator instructs the robot accelerate to a speed of 3 m/s., then one or more safe behavior guarantee modules will intervene to intercept signals corresponding to the operator instructions and modify them down to the safe maximum speed of 2 m/s. This particular example might not require characterizing the dynamics of the semi-autonomous mobile robot since, if there is sufficiently accurate absolute position sensor data available (e.g., hi-resolution GPS data) the speed can be limited to the specified 2 m/s.

The foregoing discussion is presented here merely for illustrative purposes. The presence or absence of any particular feature in the drawings is not intended to be limiting. Moreover, the extent or scope of discussion of any particular feature or the absence of discussion of any particular feature is not intended to be limiting.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for producing safe responses to human-initiated emergency stops, the acts comprising:
identifying a first module, wherein the first module is integrated into a cyber-physical system, and wherein the first module responds to an emergency response signal by:
initiating functions that are configured to achieve a first emergency response state; and
configuring a second module to be integrated into the cyber-physical system, wherein the second module responds to the emergency response signal or a derivative of the emergency response signal by initiating functions of the second module that are configured to achieve a second emergency response state,
wherein the first module is integrated into the cyber-physical system prior to identifying the first module.

1. The non-transitory computer readable medium of claim 1, wherein the cyber-physical system has both, a first collection of emergency stop functionalities and a second collection of emergency stop functionalities.

2. The non-transitory computer readable medium of claim 2, wherein the second collection of emergency stop functionalities is embodied as one or more add-on capabilities.

3. The non-transitory computer readable medium of claim 2, further comprising instructions which, when stored in memory and executed by the processor cause the processor to perform further acts of, scanning the cyber-physical system to identify cyber-physical system components that implement at least some of the first collection of emergency stop functionalities.

4. The non-transitory computer readable medium of claim 2, further comprising instructions which, when stored in memory and executed by the processor cause the processor to perform further acts of, receiving a list of system components of the cyber-physical system that implement at least some of the first collection of emergency stop functionalities.

5. The non-transitory computer readable medium of claim 1, further comprising instructions which, when stored in memory and executed by the processor cause the processor to perform further acts of, initiating functions of the second module that are configured to achieve a second emergency response state, wherein the second emergency response state is different from the first emergency response state.

6. The non-transitory computer readable medium of claim 6, further comprising instructions which, when stored in memory and executed by the processor cause the processor to perform further acts of, intercepting an emergency response signal and substituting the emergency response signal with a derivative emergency response signal that instructs the second module to achieve a second emergency response state rather than instructing the cyber-physical system to achieve the first emergency response state.

7. A method for producing safe responses to human-initiated emergency stops, the method comprising:
identifying a first module, wherein the first module is integrated into a cyber-physical system, and wherein the first module responds to an emergency response signal by:
initiating functions that are configured to achieve a first emergency response state; and
configuring a second module to be integrated into the cyber-physical system, wherein the second module responds to the emergency response signal or a derivative of the emergency response signal by initiating functions of the second module that are configured to achieve a second emergency response state,
wherein the first module is integrated into the cyber-physical system prior to identifying the first module.

8. The method of claim 8, wherein the cyber-physical system has both, a first collection of emergency stop functionalities and a second collection of emergency stop functionalities.

9. The method of claim 9, wherein the second collection of emergency stop functionalities is embodied as one or more add-on capabilities.

10. The method of claim 9, further comprising, scanning the cyber-physical system to identify cyber-physical system components that implement at least some of the first collection of emergency stop functionalities.

11. The method of claim 9, further comprising, receiving a list of system components of the cyber-physical system that implement at least some of the first collection of emergency stop functionalities.

12. The method of claim 8, further comprising, initiating functions of the second module that are configured to achieve a second emergency response state, wherein the second emergency response state is different from the first emergency response state.

13. The method of claim 13, further comprising, intercepting an emergency response signal and substituting the emergency response signal with a derivative emergency response signal that instructs the second module to achieve a second emergency response state rather than instructing the cyber-physical system to achieve the first emergency response state.

14. A system for producing safe responses to human-initiated emergency stops, the system comprising:
a storage medium having stored thereon a sequence of instructions; and
a processor that executes the sequence of instructions to cause the processor to perform acts comprising,
identifying a first module, wherein the first module is integrated into a cyber-physical system, and wherein the first module responds to an emergency response signal by:
initiating functions that are configured to achieve a first emergency response state; and
configuring a second module to be integrated into the cyber-physical system, wherein the second module responds to the emergency response signal or a derivative of the emergency response signal by initiating functions of the second module that are configured to achieve a second emergency response state,
wherein the first module is integrated into the cyber-physical system prior to identifying the first module.

15. The system of claim 15, wherein the cyber-physical system has both, a first collection of emergency stop functionalities and a second collection of emergency stop functionalities.

16. The system of claim 16, wherein the second collection of emergency stop functionalities is embodied as one or more add-on capabilities.

17. The system of claim 16, further comprising instructions which, when stored in memory and executed by the processor cause the processor to perform further acts of, scanning the cyber-physical system to identify cyber-physical system components that implement at least some of the first collection of emergency stop functionalities.

18. The system of claim 16, further comprising instructions which, when stored in memory and executed by the processor cause the processor to perform further acts of, receiving a list of system components of the cyber-physical system that implement at least some of the first collection of emergency stop functionalities.

19. The system of claim 15, further comprising instructions which, when stored in memory and executed by the processor cause the processor to perform further acts of, initiating functions of the second module that are configured to achieve a second emergency response state, wherein the second emergency response state is different from the first emergency response state.

20. The system of claim 20, further comprising instructions which, when stored in memory and executed by the processor cause the processor to perform further acts of, intercepting an emergency response signal and substituting the emergency response signal with a derivative emergency response signal that instructs the second module to achieve a second emergency response state rather than instructing the cyber-physical system to achieve the first emergency response state.
